(19) United States
(12) Patent Application Publication
(10) Pub. No.: US 2023/0409100 A1
(43) Pub. Date: Dec. 21, 2023

(54) DYNAMIC INPUT POWER MONITOR

(71) Applicant: Intel Corporation, Santa Clara, CA (US)

(72) Inventors: Shailendra Singh Chauhan, Bangalore (IN); Arvind Sundaram, Bangalore (IN); Manasa Nagamangala Sridhara, Bangalore (IN); Anil Kumar Nama, Bangalore (IN); Ramesh Vankunavath, Bangalore (IN); Manjunath Channipura Hombaiah, Bangalore (IN); Siva Prasad Jangili Ganga, Bangalore (IN); Kunal Shah, Bangalore (IN); Venkata Mahesh Gunnam, Andhra Pradesh (IN); Chuen Ming Tan, Bayan Lepas (MY); Venkataramana Kotakonda, Bangalore (IN)

(21) Appl. No.: 17/841,550

(22) Filed: Jun. 15, 2022

(51) Int. Cl. G06F 1/30; G06F 1/28

(52) U.S. Cl. CPC G06F 1/30; G06F 1/28

(57) ABSTRACT

Embodiments herein relate to a power monitor that can be used to dynamically change a power level of an electronic device and/or operational settings of a processor of the electronic device. Specifically, the power monitor may be configured to identify “droop” of power, and logic to update the power level and/or operational settings in accordance with identification of the droop. Other embodiments may be described and claimed.

### FIELD

The present application generally relates to the field of electronic circuits and, more specifically, to a power monitor for use in or with an electronic device and associated apparatuses, systems, and methods.

### BACKGROUND

Computing devices may be used in a variety of configurations such as at work, education, gaming, web browsing, personal multimedia, and general home computer user. Each segment of electronic devices may have different power profile demand depending on factors such as use case, cost, and/or segment requirements.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates an example of a power-adapter dongle, in accordance with various embodiments.

FIG. 2 illustrates a detailed example workflow related to the power-adapter dongle of FIG. 1, in accordance with various embodiments.

FIG. 3 illustrates an example of a communication process flow related to the power-adapter dongle of FIG. 1, in accordance with various embodiments.

FIG. 4 illustrates a simplified example workflow related to the power-adapter dongle of FIG. 1, in accordance with various embodiments.

FIG. 5 illustrates an example electronic device, in accordance with various embodiments.

FIG. 6 illustrates a detailed example workflow related to the electronic device of FIG. 5, in accordance with various embodiments.

FIG. 7 illustrates a simplified example workflow related to the electronic device of FIG. 5, in accordance with various embodiments.

FIG. 8 illustrates an example technique that may be performed by one or more elements of the power-adapter dongle of FIG. 1, in accordance with various embodiments.

FIG. 9 illustrates an example technique that may be performed by one or more elements of the electronic device of FIG. 5, in accordance with various embodiments.

FIG. 10 illustrates a smart device or a computer system or a System-on-Chip (SoC) with apparatus and/or software for a power monitor, in accordance with some embodiments.

### DETAILED DESCRIPTION

As previously noted, computing devices may be used in a variety of configurations such as at work, education, gaming, web browsing, personal multimedia, and general home computer user. Each segment of electronic devices may have different power profile demand depending on factors such as use case, cost, and/or segment requirements.

In addition to the different power profile demand, some computing devices that cater to a mobile market (e.g., laptops or some other mobile device) may be powered by a universal serial bus (USB) Type-C port. However, legacy devices may have used ports with different form factors such as a generally tubular port, a flat port, or some other type of form factor. As such, a number of power adapters (e.g., the element that may plug into a wall socket at one end and the electronic device) at the other may be present, but unable to plug into the USB Type-C port. Replacing these devices may be costly both in terms of cost to a purchaser of the new electronic device as well as the generation of e-waste that may result from replacement of the power adapter. Some embodiments herein may therefore relate to a power dongle that is capable of being positioned between the power adapter and the Type-C port of the electronic device. The dongle may have a number of multi-type ports to account for the different form factors of the power adapters as described above. Additionally, the dongle may have power-monitor circuitry configured to communicate with an embedded controller (EC) of the electronic device to negotiate different power levels to be provided to the electronic device.

Additionally, in some embodiments the power adapter and/or dongle may not be equipped to provide the amount of power to the electronic device that the electronic device may require for certain tasks. Such tasks may include a system boot or wake process, or performing a given workload. Therefore, some embodiments may relate to inclusion of power-monitor circuitry in the electronic device to monitor the power provided by the power adapter and/or dongle, and adjusting the operational parameters of the electronic device accordingly.

### Power Dongle With Power Monitor

As noted, in some embodiments a power dongle may be used to allow coupling of a legacy power adapter to a Type-C USB port of an electronic device such as a laptop. The dongle may convert the power output by the power adapter to a required power profile for the electronic device. Such conversion may be based on or include a feedback loop that includes the power monitor as will be described in greater detail below.

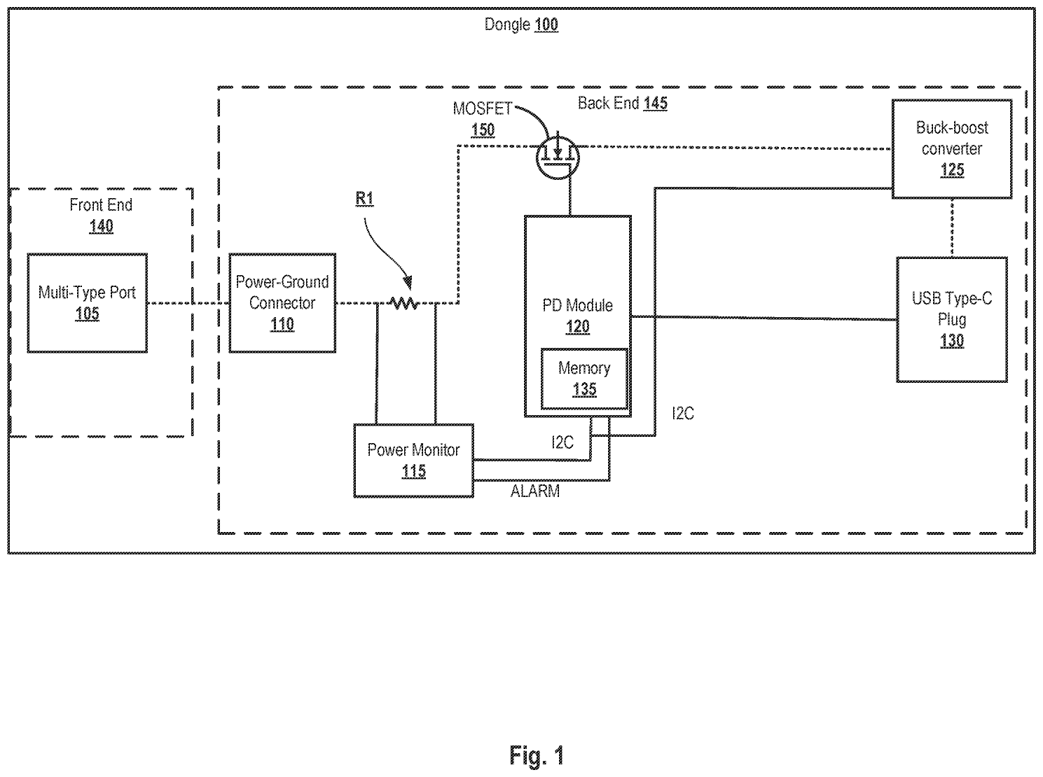

FIG. 1 illustrates an example of a dongle 100, in accordance with various embodiments. As may be seen, the dongle 100 may include a front end 140 and a back end 145. It will be noted that the “front end” 140 and the “back end” 145 may be conceptually separated rather than structurally, while in other embodiments the front end 140 and back end 145 may be separated by some structural component (e.g., separate cavities of a physical structure, separate boards, etc.). For the sake of description, FIG. 1 depicts two general communications paths. The connections shown with dotted lines may be referred to as the “power path,” while the connections shown with solid lines may be referred to as the “signal path.” The power path may be the communications pathway that the power signal traverses from the multi-type port 105 to the USB Type-C plug 130. The signal path may be the pathway that signals traverse between elements that shape, control, or otherwise affect the power path. It will be noted that the elements depicted in FIG. 1 may be implemented as hardware, software, firmware, and/or some combination thereof. Additionally, it will be noted that the depiction of FIG. 1 is intended as a highly simplified block diagram, and real-world embodiments may include more elements (e.g., if certain elements are separated), fewer elements (e.g., if elements are combined), elements arranged in a different order, etc.

The front end 140 may include a multi-type port 105. Specifically, the port may be configured to be swapped by a user to have one of a number of possible form factors to couple with legacy power adapters. For example, in some embodiments at least a portion of the multi-type port 105 may be removable from the dongle 100 such that it may be replaced by another element. In this way, the multi-type port 105 may be reconfigurable using different elements to couple with power adapters that have or include one or more of a variety of different form factors.

As noted above, such form factors may include a tube shape (with or without one or more pins), a generally flat shape, or some other shape. In some embodiments described herein, such power adapters may be, for example, power adapters that receive an alternating current (AC) power signal and output a direct current (DC) power signal. Such adapters are referred to herein as DC power adapters for the sake of discussion. It will be noted that other embodiments may include different power adapters (e.g., DC to DC, DC to AC, AC to AC, etc.).

The back end 145 may include a power-ground connector 110 which, in some embodiments, may be a 2-pin power-ground connector. The power-ground connector 110 may be configured to facilitate transmission of the power from the front end 140 to the back end 145. The power-ground connector 110 may be coupled with a MOSFET 150 and a power monitor 115 may monitor the power (e.g., the voltage or current) that is going between the Power-Ground Connector 110 and the MOSFET 150. As may be seen, in some embodiments the power monitor 115 may monitor the voltage across a resistor R1. Such monitoring may be constant, or it may be performed according to some time interval (e.g., every x time intervals).

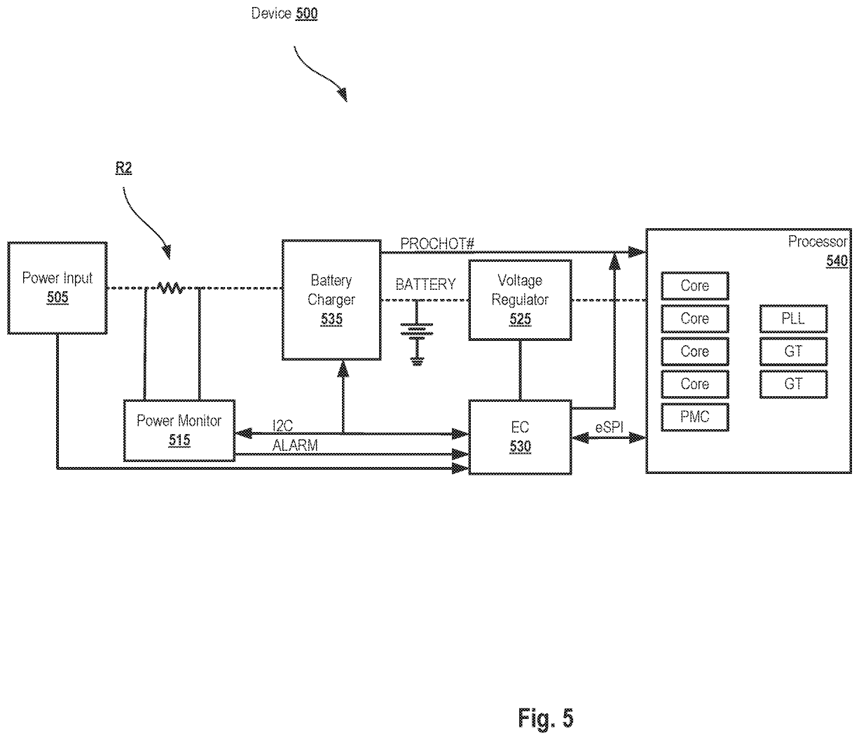

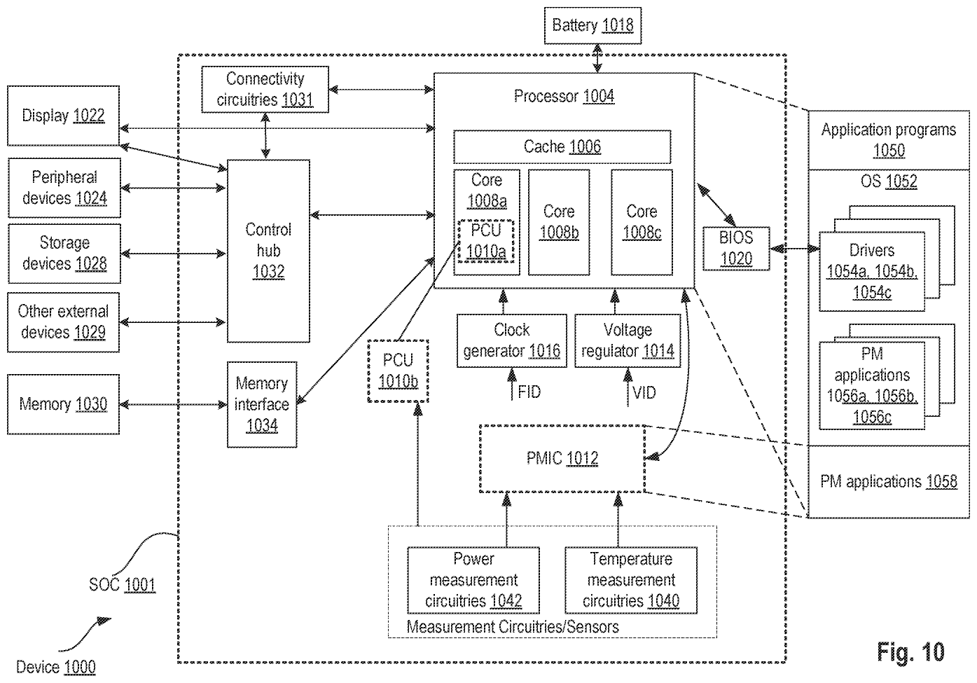

The MOSFET 150 and the Power Monitor 115 may be coupled with a power delivery (PD) module 120 that includes a memory 135. The memory 135 may be, for example, an electrically erasable programmable read-only memory (EEPROM) or some other type of memory. The PD module 120 may be configured to act as a logic acts upon the instructions or data stored in the memory 135. Generally, the PD module 120 may be configured to operate the MOSFET 150 to transfer the power received from the multi-type port 105 to a buck-boost converter 125 that is coupled with a USB Type-C plug 130. Generally, the buck-boost converter may be a DC-to-DC converter that is able to increase or decrease an input voltage magnitude. The buck-boost converter 125 may accept as input the power signal from the MOSFET 150 and output a power signal (with, in some embodiments, an increased or decreased voltage) to the USB Type-C plug 130. The USB Type-C plug may be coupled with the electronic device (e.g., a laptop or some other electronic device) by a USB cable that is not shown. The electronic device may be similar to, for example, the electronic device of FIG. 5, the electronic device of FIG. 10, or some other electronic device.

In operation, when a power adapter is connected to the multi-type port 105 of the dongle 100, the PD Module 120 may boot up (i.e., “power on”) based on the power provided by the power adapter and load its boot loader (e.g., from the memory 135 and/or some other memory or firmware that is part of or coupled with the PD module 120). As part of the boot process, the PD Module 120 may provide a signal to MOSFET 150 that effectively closes the MOSFET 150 and allow power to flow along the power path to the buck-boost converter 125. The power monitor 115 may continuously monitor the adapter voltage at resistor R1 for “droop.” As used herein, “droop” may refer to the loss in power from a device as it drives a load. Specifically, the power monitor 115 may support a variety of features such as voltage measurement and current measurement. In some embodiments, the “power droop” may additionally or alternatively be referred to as “voltage droop” or “current droop.”

Generally, pins of the power monitor 115 may be connected across the resistor R1. The power monitor 115 may include an analog-to-digital converter (ADC) that is configured to sense the voltage on each of the pins. Based on the difference of voltage sensed on either side of resistor R1, the power monitor 115 may be configured to identify the voltage drop across the resistor R1. The current may be identified as the voltage change divided by the resistance of resistor R1 (I=V/R), and the power may therefore be identified as I²R. This power may then be used to identify the power droop. For example, when the voltage changes, the resultant measured power will similarly change. A change in the voltage, current, and/or power beyond a pre-specified threshold (e.g., 10%) may be referred to as “droop.” It will be noted that this threshold is only one example and other embodiments may be based on different thresholds such as 5%, 15%, etc.

After the PD Module 120 boots up (which may include, e.g., loading the necessary firmware for operation), the PD Module 120 may initialize communication between the Type-C plug 130 and the electronic device to which the dongle 100 is coupled. Such communication may be, for example, over a communication channel (CC) of the USB Type-C connection between the dongle 100 and the electronic device to which the dongle 100 is coupled. In some embodiments, such communication may be referred to as “negotiation.” Based on the communication, the dongle 100 (and, particularly, the PD Module 120) may query the electronic device regarding the maximum power profile that the electronic device is capable of supporting. The electronic device may respond with an indication of a power level that may be stored, for example, in memory 135 and/or some other memory.

Based on the maximum power profile, the PD module 120 may initialize the buck-boost converter 125 over the I2C line such that the power supplied by the buck-boost converter 125 to the Type-C plug 130 is in accordance with the maximum power profile. The power is then provided to the electronic device via the Type-C plug 130. Based on this power, the electronic device may boot to an active state (e.g., an SO state or some other state) using the power provided by the dongle 100. In some embodiments, the EC of the electronic device (similar to the EC depicted with respect to FIG. 5) may provide an indication of the default charger setting to a battery charger (e.g., the battery charger of FIG. 5) of the electronic device.

However, if the power adapter connected to the dongle 100 does not support the power level that was indicated by the electronic device as previously described, then the power monitor 115 may identify a power droop as described above. Based on the identified droop, the power monitor 115 may transmit an alarm signal to the PD module 120. Based on the alarm signal, the PD module 120 may re-initialize communication with the electronic device (e.g., over the CC line of the USB Type-C communicative coupling) to identify a new power level to be supplied to the electronic device. Specifically, this new power level may be less than the previous power level.

The feedback process of identifying droop, asserting an alarm, and then re-negotiating a lower power level may continue until the power monitor 115 stops asserting an alarm to the PD module 120. In some cases, such cessation may be based on a lack of assertion over a specific time threshold (which may be, e.g., stored in memory 135 or may be dynamic). In other cases, such cessation may be based on an explicit de-assertion of the alarm signal.

It will be understood that this description of an alarm based on identified power droop is intended as an example of one embodiment. In other embodiments, the alarm may be triggered based on another factor or identification. For example, in some embodiments the dongle 100, and particularly the power monitor 115 or PD module 120, may be configured to communicate with the power adapter when the power adapter is coupled with the front end 140. As part of such communication, the power adapter may communicate (for example, through a signal during a “handshake” type process) the power level that is supported by the power adapter. In this case, the power monitor 115 may assert an alarm signal as described above. The PD module 120 may be configured to, either based on the alarm signal or based on the communication with the power adapter, identify the power level supported by the power adapter (either through communication with the power monitor 115 or directly with the power adapter). The PD module 120 may then be configured to re-negotiate the lower power level as described above. In other embodiments, such re-configuration may additionally or alternatively be based on one or more additional or alternative factors.

The electronic device may then finish booting up, initiate a workload, etc. It will be noted that once a workload is initiated a new power droop may be identified at the dongle 100, and a new power level negotiation may be performed. In some embodiments, the power level provided by the dongle 100 to the electronic device may stay consistent until such time as the dongle 100 is de-coupled from the electronic device, at which point the power level stored in the memory 135 may be cleared. In other embodiments, the power level stored in the memory 135 may remain persistent between uses. It will be noted that, in some situations, the battery and/or battery-charger of the electronic device may supplement the power droop with battery power while the new power level is being negotiated.

It will be noted that, in some embodiments, the dongle 100 may be used based on a nearest power profile of the power adapter. For example, a power adapter may be rated for between 55 and 65 Watts (W). The negotiated power level used with the electronic device may be 60 W.

In some embodiments, an exceptional case may arise wherein a power adapter with a low power profile (e.g., that outputs a lower amount of power) is used for charging. As one example, a power adapter may output between approximately 25 and approximately 30 W, and the electronic device may typically use between approximately 45 W and approximately 60 W.

In this case, the EC of the electronic device may pause booting if the electronic device is in the boot-up process, or throttle the processor of the electronic device if the electronic device is already booted. The EC may additionally or alternatively reconfigure settings for a battery charger or battery charging controller of the electronic device for the reduced power profile.

Another exceptional case may arise when an alert is asserted by the power monitor 115 when the electronic device to which the dongle 100 is coupled is still booting. In this situation, the power monitor 115 may identify droop and assert the alert to the PD module 120. The PD module may identify (either with or without communication with the electronic device) the next lower power level and, in some cases, inform the electronic device of the next lower power level. The policy manager of the electronic device may update the battery charger settings of the electronic device accordingly. In some specific cases, the assertion of the alert during the boot process may result in the electronic device crashing and/or rebooting.

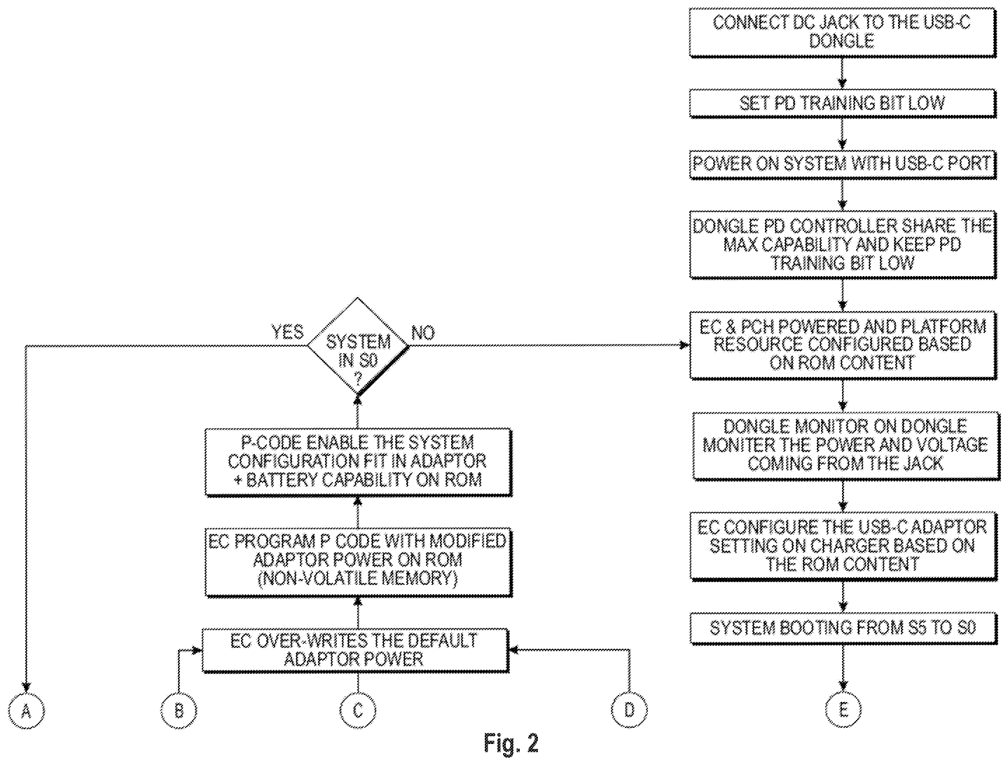

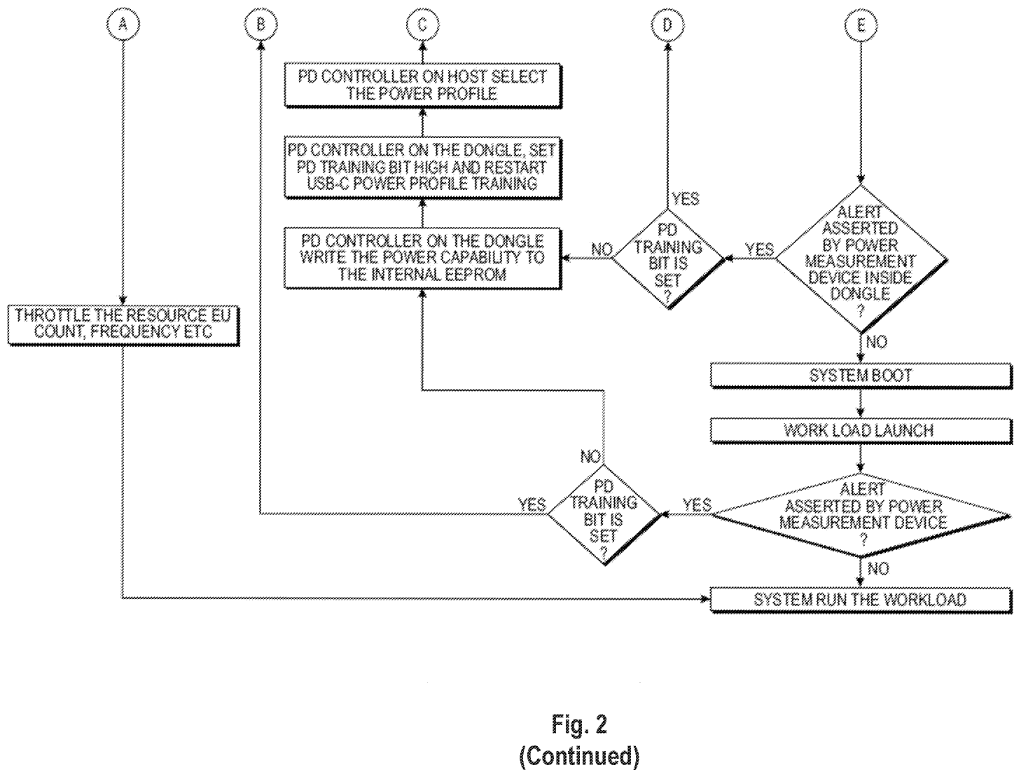

FIG. 2 illustrates a detailed example workflow related to the power-adapter dongle of FIG. 1, in accordance with various embodiments. It will be understood that the workflow may be a high level workflow related to functions of different elements of the dongle and the electronic device to which the dongle is coupled. For example, elements that refer to the EC may be performed by the electronic device, whereas elements referred to the PD controller/PD module may be related to functions performed by a dongle such as dongle 100.

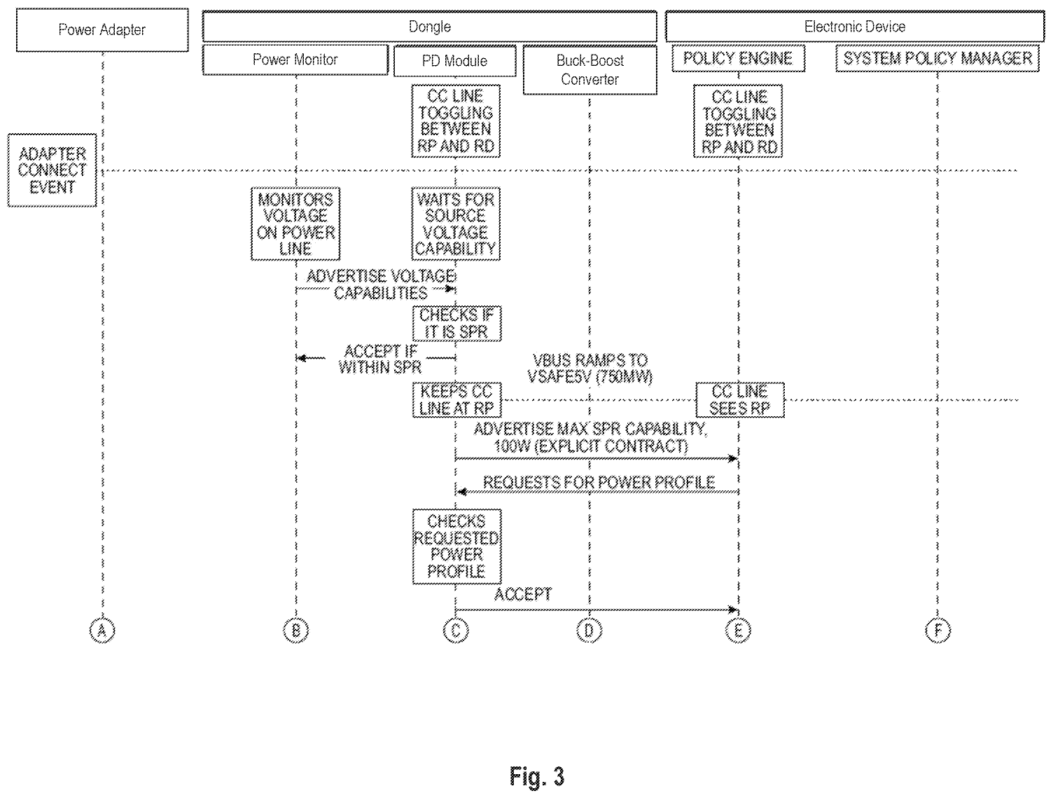

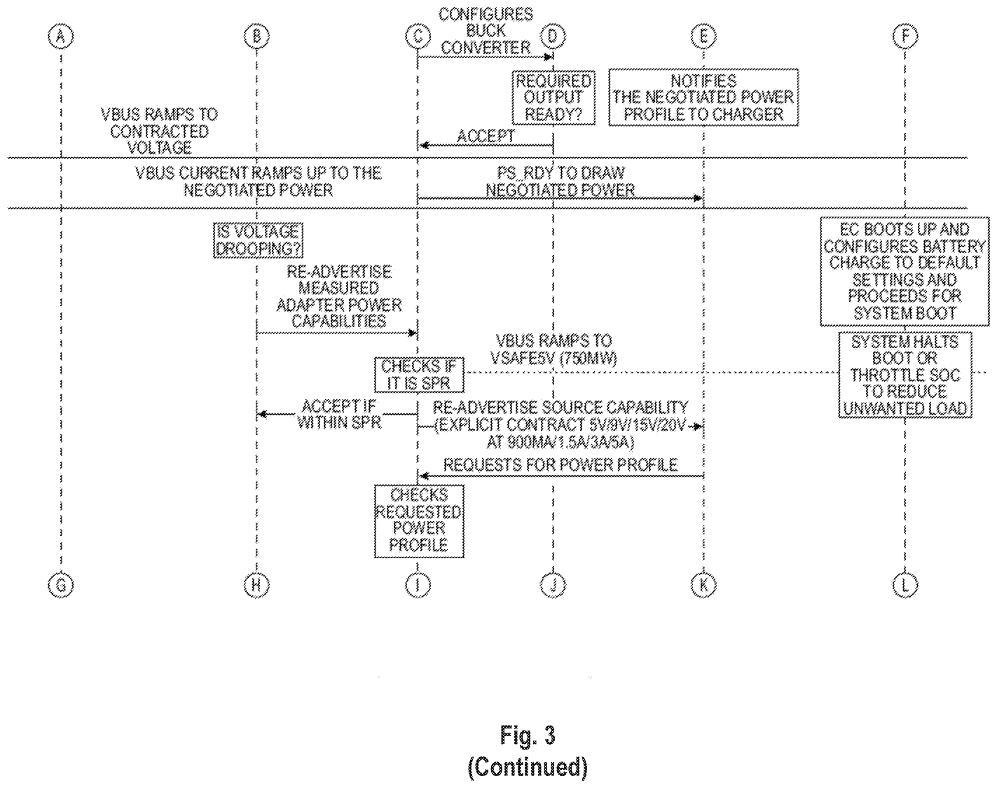

FIG. 3 illustrates an example of a communication process flow related to the power-adapter dongle of FIG. 1, in accordance with various embodiments. Specifically, FIG. 3 depicts a highly detailed example of the communication flow between the power adapter (referred to as a standard barrel/flat adapter), a dongle (which may be similar to the dongle 100), and a dual-role power (DRP) system which may be similar to the electronic device described with respect to FIG. 5. The electronic device may include, for example, a policy engine (which may be similar to, or implemented by, one or both of EC 530 and processor 540) and a system policy manager (which may also be similar to, or implemented by, one or both of EC 530 and processor 540).

As may be seen, the dongle may include a power monitor (similar to power monitor 115), a PD module (similar to PD module 120), and a buck-boost converter (similar to buck-boost converter 125). As may be seen, the power monitor and the PD controller may be coupled by an I2C communication pathway. Similarly, the PD controller and the buck-boost converter may be coupled by an I2C communication pathway. Similarly, the PD controller 120 and the policy engine of the electronic device may be communicatively coupled by a CC line as described above. Some elements of FIG. 3 that may be noted by a person of skill in the art is that, once an alert is asserted by the power monitor, VBUS may go to a Vsafe5V power profile. Specifically, when the alarm is asserted by the power monitor, the VBUS may go to a pre-identified “safe” power profile while the next lower power profile is negotiated. Additionally, VBUS may ramp to the currently-negotiated power profile once the alert is de-asserted by the voltage monitor device.

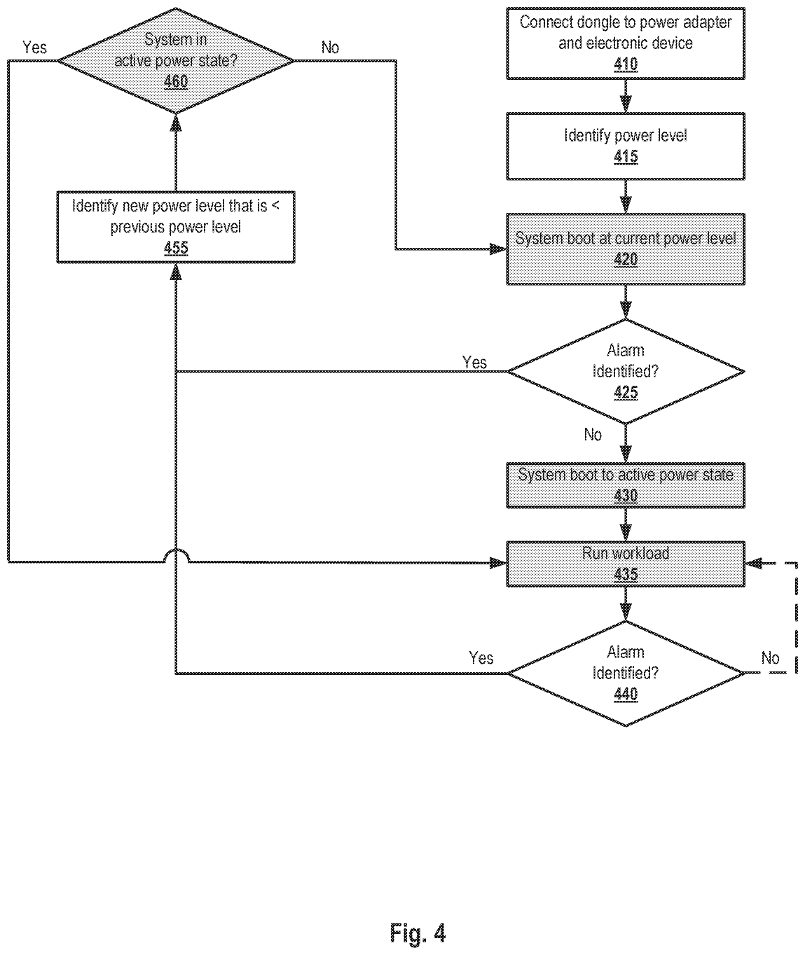

FIG. 4 illustrates a simplified example workflow related to the power-adapter dongle of FIG. 1, in accordance with various embodiments. Generally, the simplified example workflow of FIG. 4 may be considered to be a simplified workflow that is similar to that of FIG. 2 and/or 3. It will be noted that elements of the workflows or processes depicted with respect to FIGS. 2-4 are intended as examples, and other embodiments may have more or fewer elements, elements arranged in a different order than depicted, etc. It will be noted that, with respect to FIG. 4, elements with gray shading may be considered to be performed at least partially be an electronic device coupled with the dongle, as will be described in greater detail below. Additionally, it will be noted that although the re-negotiation of the power level is based on identification of power droop, in other embodiments the power level re-negotiation at 455 may be based on a factor such as communication with the power adapter and/or identification of a power level that is supported by the power adapter, as previously described.

The process may begin with coupling the dongle 100 to a power adapter and an electronic device at 410. As described, at such connection the dongle 100 may power-on based on the power provided by the power adapter and identify an initial power level at 415. The electronic device may then start a boot process based on the initial power level at 420.

As noted, in some cases the load introduced based on the system boot process at 420 may cause droop, which may be identified by the power monitor 115. The power monitor 115 may assert an alarm to the PD module 120. If the alarm is not identified at 425, then the electronic device may proceed with booting at 430 and run a workload at 435. The workload at 435 may be, for example, operating certain hardware components (e.g., processors or cores of the electronic device), operating certain processes or software, etc.

The PD module 120 may then continue to monitor whether an alarm is identified at 440 based on running the workload. If no alarm is identified at 440, then the electronic device may continue running the workload at 435.

However, if the alarm is identified at 425 or 440, then the PD module 120 may identify a new power level that is less than the previous power level 455. This identification may be performed in accordance with a variety of factors. For example, in one embodiment the new power level may be a percentage of the previous level (e.g., 90% of the previous level, 80% of the previous level, etc.). In another embodiment, the new power level may be an amount lower than the previous power level (e.g., the new power level may be 10 W lower than the previous power level, 5 W lower than the previous power level, etc.) In some embodiments, the memory 135 may include a pre-defined set of power levels that arranged in a data structure such as a table. In this case, the new power level may increment through the data structure to identify a new power level. These are just examples, and other embodiments may include additional or alternative factors.

After identifying the new power level (which may include notification of the new power level to the electronic device), the process may continue as shown in FIG. 4. Specifically, if the electronic device is not in the active power state at 460 (e.g., the electronic device is not booted up), then the electronic device may restart or continue the boot process at the currently negotiated power level at 420. However, if the electronic device is in the active power state at 460 (e.g., the electronic device is booted up), then the electronic device may begin to run the workload at 435.

It will be noted that, in some embodiments, the process may have an end point subsequent to elements 435/440 if a certain amount of time has elapsed after de-assertion of the alarm, or an explicit de-assertion of the alarm, as described above. However, the specific decision is not depicted in FIG. 4 for sake of clarity of the Figure.

### Electronic Device With Power Monitor

In some situations, if the power provided by the power adapter is not sufficient for system needs, a similar power monitoring mechanism may be desirable for use with an electronic device. Specifically, when an electronic device is powered-off, it may need a relatively high amount of power to boot back up. Additionally or alternatively, the electronic device may require a relatively high amount of power to perform certain workloads.

However, as described above, in some cases a power adapter such as a legacy power adapter (which may or may not be coupled with the electronic device by a dongle such as dongle 100) may provide a lower amount of power than the electronic device may require for full operation.

As such, embodiments in this section may relate to an electronic device that includes a power monitor similar to power monitor 115 of FIG. 1. Specifically, in some embodiments the electronic device may be configured to identify the power capability of the power adapter. Additionally, the electronic device may be configured to adjust operational parameters of the electronic device based on the power capability of the power adapter. Specifically, a power monitor may be positioned to monitor and measure an input power received from the power adapter. Whenever there is a certain amount of power droop, the power monitor may trigger an interrupt to an EC of the electronic device. Based on the interrupt, the EC may identify how much power is being provided by the power adapter, and then adjust one or more operational parameters of the system to adapt the operational parameters of the electronic device to the available power level.

As a result, embodiments may enable a user to use power adapters with low power ratings to boot the electronic device or perform certain workloads. As such, the need for a specific power rating to boot the electronic device or to wait until the battery is charged may be eliminated or reduced.

FIG. 5 illustrates an example electronic device 500, in accordance with various embodiments. Specifically, the electronic device 500 may be a mobile electronic device such as a laptop computer or some other electronic device. It will be noted that, similarly to FIG. 1, the elements depicted in FIG. 5 may be implemented as hardware, software, firmware, and/or some combination thereof. Additionally, it will be noted that the depiction of FIG. 5 is intended as a highly simplified block diagram, and real-world embodiments may include more elements (e.g., if certain elements are separated), fewer elements (e.g., if elements are combined), elements arranged in a different order, etc. Similarly to FIG. 1, FIG. 5 may depicted a power path as indicated by the dotted line, and a signal path as indicated by the solid lines.

It will be understood that embodiments herein may be described with respect to power identification based on power droop in a manner similar to that of FIG. 1. However, as previously described, such description of an alarm based on identified power droop is intended as an example of one embodiment. In other embodiments, the power identification may be based on another factor or identification. For example, in some embodiments the identification of the power supplied at the power input 505 may be based on communication from the power supply (for example, through a signal during a “handshake” type process), or some other technique as previously described. In other embodiments, such power identification may additionally or alternatively be based on one or more additional or alternative factors.

The electronic device 500 may include a power input 505 configured to receive power. In some embodiments, the power input 505 may be a USB Type-C port configured to couple with a dongle such as dongle 100. In some embodiments, the power input 505 may be a port configured to couple with a DC power adapter such as one of the power adapters described with reference to FIG. 1. The power input 505 may be configured to provide a power signal output to the battery charger 535. A power monitor 515, which may be similar to power monitor 115, may be configured to monitor the power provided by the power input 505 across resistor R2 (which may be similar to resistor R1).

The battery charger 535 may accept the power received from the power input 505 and provide power to one or both of the battery (un-enumerated based on lack of space in the Figure) and the voltage regulator 525. The voltage regulator 525 may be configured to accept the power from the battery charger 535 and/or the battery and provide power to the processor 540 at the profile level identified by the EC 530

As may be seen in FIG. 5, the processor 540 may include one or more elements such as a number of processor cores, a power management controller (PMC), a phase lock loop (PLL), and one or more graphics tiles (GTs). The processor cores may be configured to operate jointly or separately to perform one or more calculations or tasks. The PMC may be configured to provide power to one or more other elements of the processor 540, turn different elements on or off, etc. The PLL may serve to manage a clock of the processor. The GT(s) may serve to render graphics on a user display (e.g., for gaming or other applications). It will be noted that although only a certain number of elements (e.g., four cores) are shown, other embodiments may have processors with more or fewer elements than depicted, different elements, etc. Additionally, in some embodiments each of the cores of the processor 540 may be the same as one another while, in other embodiments, the one or more of the cores of the processor 540 may be different than another of the cores of the processor 540.

As may be seen, the electronic device 500 may further include an EC 530, which may be configured to control one or more elements of the electronic device 500. For example, the EC 530 may be configured to communicate with one or more of the power monitor 515, the battery charger 535, the voltage regulator 525, and the processor 540. Generally, as used herein, an “EC” may refer to a microcontroller that may be configured to perform various functions in, to, or on behalf of, the electronic device. In embodiments, the EC may include one or more elements such as one or more processors, one or more memory elements (which may be volatile and/or non-volatile), and/or one or more additional chips, modules, or elements that may be used by the EC to perform the various functions described herein.

As noted, the power monitor 515 and/or EC 530 may be configured to alter operational parameters of the electronic device in various situations. One such situation is when the electronic device 500 is booting up and the battery does not have sufficient power for the boot up process. Another such process is when the electronic device 500 and, specifically, the processor 540 of the electronic device runs a given workload (e.g., some process or software that may require system resources when the device is in an active state such as the S0 state). The following embodiment will be generally described with respect to the boot process, but it will be understood that the description may be modified to equally apply to performance of a workload.

Specifically the electronic device 500 may be in a powered-off state (e.g., a G3 state or some other low-power or mechanical-off state) due to a complete dead-battery condition. When power is supplied to the system via the power input 505, the EC 530 may be powered up and initiate or resume a system boot sequence with a default power configuration. Such power configuration may be related to one or more operational parameters of the electronic device. The operational parameters may relate to or include the number of type of cores of the processor 540 that are operational at a given time, the frequencies at which the core(s) are running at, and/or some other operational parameter of the electronic device 500.

Additionally, the power monitor 515 may monitor the power received from the power input 505. In some embodiments, such monitoring may be constant, or it may be periodic (e.g., every x time intervals). At this stage, if the power provided by the power input is acceptable for supporting system boot, then the system may reach an active (e.g., S0) state without power recycles or other issues.

However, if the power provided by the power input 505 is not capable of supporting the complete boot flow of the power required by the default power configuration, then the power monitor 515 may identify a droop as described above with respect to FIG. 1. If the droop is to a power that is below a given threshold, then the power monitor 515 may generate an alarm signal that is sent to the EC 530. In some embodiments, the alarm signal may be an interrupt.

Generally, the threshold may be based on the current power profile. For example, in one embodiment, the threshold may be between approximately 70% and approximately 90% of the power level indicated by the current power profile (e.g., if the power provided by the power input 505 is between approximately 70% and 90% of the power level indicated by the current power profile, the power monitor 515 generates the interrupt). In other embodiments, the threshold may be approximately 80% of the power level indicated by the current power profile. In some embodiments, the power level may be based on an interval (e.g., 10 W below the power level indicated by the current power profile), or some other factor.

In some embodiments, the power monitor 515 may be configured to identify that the threshold has been crossed and provide the alarm signal to the EC 530. In other embodiments, the power monitor 515 may provide an indication of each power fluctuation and the EC 530 may identify whether the threshold has been crossed.

In some embodiments, along with the alarm signal, the power monitor 515 may track, store, and/or provide an indication of the maximum power provided by the power input 505. For example, if the power monitor 515 identifies that the droop has occurred and crossed the threshold, the power monitor 515 may also identify what the maximum power level was during the droop and provide this information (either as a push to the EC 530 or in response to a query from the EC 530). Based on that information.

Once the alarm is signaled to the EC 530, the EC 530 may assert, responsive to the alarm, a PROCHOT# signal to the processor 540. The PROCHOT# signal may be a legacy signal that is typically asserted when the processor is too hot and a risk of system damage is present. Based on the PROCHOT# signal, the PMC of the processor 540 and the EC 530 may communicate (e.g., via the eSPI interface) to revise the operational parameters based on the maximum power level provided by the power monitor 515 to the EC 530. Specifically, in some embodiments the EC 530 may instruct the PMC to shut down one or more cores of the processor 540 (e.g., cores that typically draw more power or are more user experience or performance-oriented), change an operational frequency of one or more cores of the processor 540, etc. In other embodiments, the EC 530 may provide an indication of the power level to the PMC and the PMC may be configured to identify which steps to take to adjust the operational parameters. In either situation, the operational parameters of the processor 540 may be adjusted based on the maximum power provided by the power input 505.

Such reconfiguration of the operational parameters may be until such time as the battery charger 535 indicates to the EC 530 via the I2C interface that the battery is charged to an extent that it is sufficient to provide power to the processor 540, and the power profile and operational parameters may be increased back to their initial state.

As a concrete example, the electronic device may be configured to have an ideal power level of 45 W. The processor 540 may have six cores that are performance related (referred to herein as P-Cores), eight cores that are efficiency-related (referred to herein as E-cores), and 2 GTs. The minimum power limit needed to boot this system without a battery charge may be 60 W. However, if a 30 W power adapter is connected to the power input 505 and the battery is dead, droop may be identified. As a result, the EC may configure the PMC of the processor 540 to shutdown the P-Cores and boot the electronic device 500 with only the E-Cores enabled. After the boot, upon an increase in the battery charge percentage, the EC may then instruct the PMC of the processor 540 to re-enable the P-Cores.

As an alternative, rather than shutting down the P-Cores, the EC 530 may instruct the processor 540 to reduce the frequency of one or more of the cores (e.g., the P-Cores or the P-Cores and the E-Cores) during boot time. Alternatively, it may be possible reduce the power level 2 (PL2) and/or power level 4 (PL4) numbers based on the droop, and then increase them as the battery charge percentage increases. As used herein, PL2 and PL4 refer to temporary increases in operating frequency that do not exceed the thermal budget of the processor 540.

In some embodiments, when a user removes the power adapter from being coupled with the power input, the EC may identify the de-coupling and reset one or both of the power threshold and/or operational parameters of the system to a default configuration such that the process may be re-performed based on the parameters of the new power adapter coupled with the system.

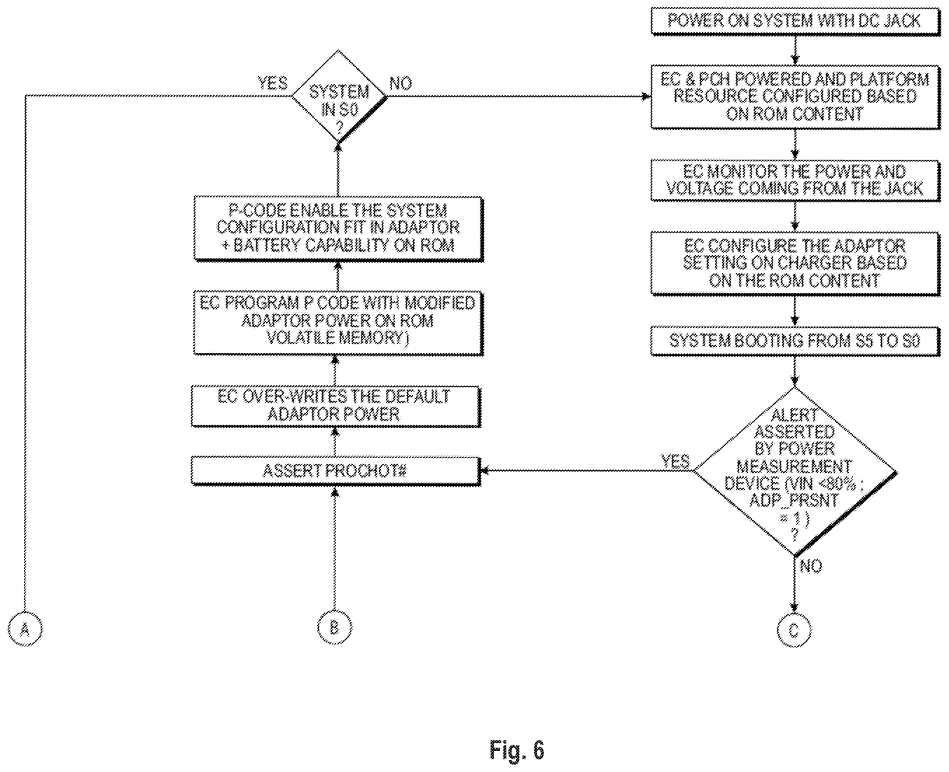

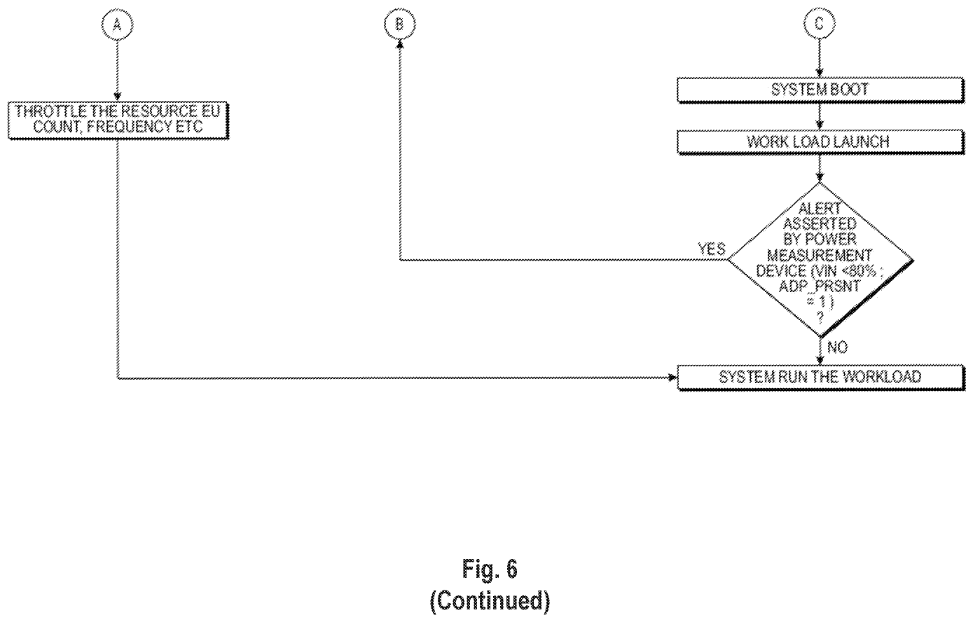

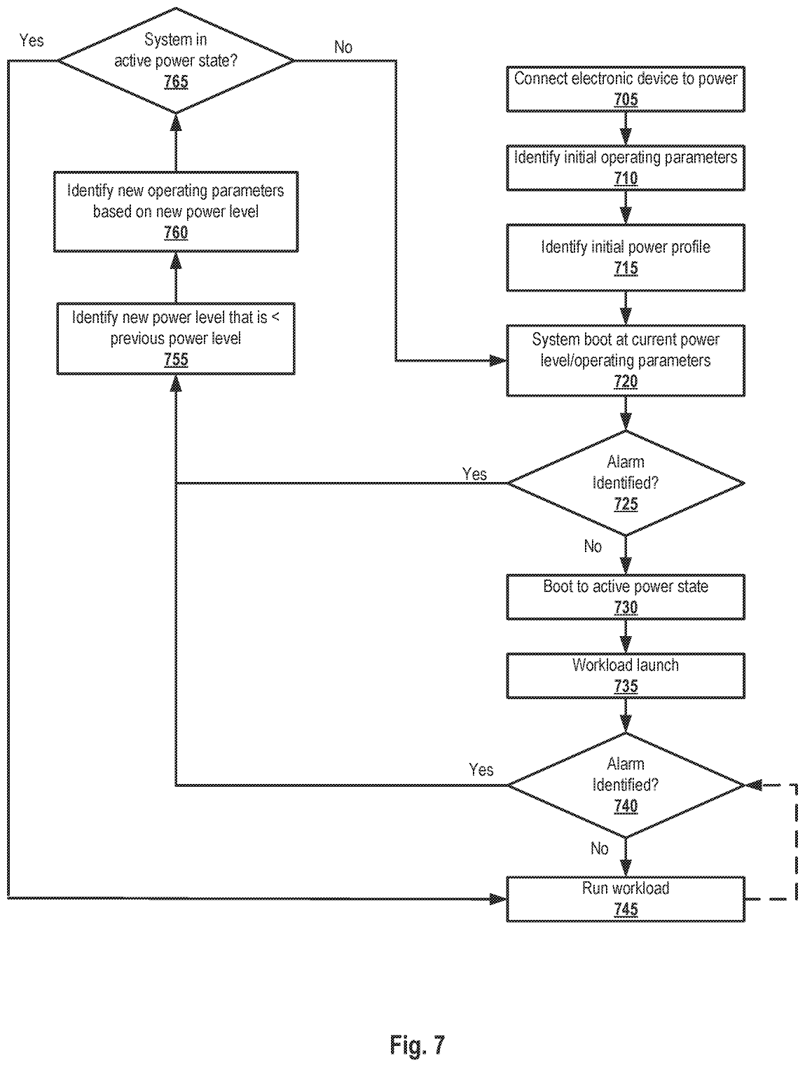

FIG. 6 illustrates a detailed example workflow related to the electronic device of FIG. 5, in accordance with various embodiments. Specifically, the workflow depicted in FIG. 6 may include various specific elements that are depicted for the sake of showing on specific example. FIG. 7 illustrates a simplified example workflow related to the electronic device of FIG. 5, in accordance with various embodiments, which may be considered a simplified version of the workflow of FIG. 6. It will be understood that the embodiments of FIGS. 5 and 6 are intended as examples for the sake of discussion herein, and other embodiments may include more, fewer, or different elements than are depicted in FIG. 5 or 6. In some embodiments the elements may be arranged in a different order than depicted. Similarly to FIG. 4, is will be understood that the embodiment of FIG. 7 is described with respect to power droop, but in other embodiments an additional or alternative technique of power identification (e.g., communication between the electronic device and the power supply) may trigger the identification of the new power level at 755.

The process may begin at 705 when the electronic device is connected to power, for example by connecting a power adapter or a dongle to the power input 505. The EC 530 may identify one or both of initial operating parameters of the system at 710 and an initial power profile at 715. The power profile may include information related to an initial power level to be used by, or supplied to, the system. Generally, the power profile may be based on the operating parameters. In other words, the power profile may be based on ensuring that sufficient power is present for the electronic device to operate in accordance with the initial operating parameters. In some embodiments, the EC 530 may be configured to identify the operating parameters based on a query to the processor 540. In some embodiments, the EC 530 may be configured to identify the power profile based on the identification of the operating parameters. In some embodiments, the EC 530 may identify one or both of the operating parameters and the power profile based on a pre-stored setting or value in a memory.

The system boot process may then be started at 720. As described above, the boot process may be a process that is performed by the electronic device, one or more elements of the electronic device, or some other component related to bringing the system from a low-power state (e.g., a sleep or powered-off state such as a G3 state) to an active state (e.g., an S0 state).

The power monitor 515 may monitor for droop as described above and, in the event that droop is identified, generate an alarm (e.g., an interrupt) to the EC 530. As noted above, the alarm may be based on the droop being to a power below a threshold.

If no alarm is identified by the EC 530 at 725, then the electronic device may finish booting to an active power state at 730 and launching a workload at 735. The power monitor 515 may monitor for droop during performance of the workload. If no alarm is identified at 740, then the electronic device 700 and, particularly, the processor 540, may run the workload at 745. In some embodiments, as indicated by the dashed line, the EC 530 may continue to monitor for an alarm at 740.

If an alarm is identified at 725 or 740, then the system may proceed to 755 where a new power level is identified. Specifically, the new power level may be based on the information related to the maximum power level provided by the power input 505 during occurrence of the droop. As noted, such information may come from the power monitor 515. The EC may additionally communicate with the processor 540 and, particularly, the PMC of the processor 540 to identify new operating parameters based on the new power level at 760. Such new operating parameters may relate to changing a frequency of operation of one or more cores of the processor 540, changing which cores are active, or some other parameter.

If the system was not in the active power state at 765, then the process may return to 720 where system boot may continue or restart. If the system is in the active power state, then the process may return to 745 where the workload is performed 745.

### Example Techniques

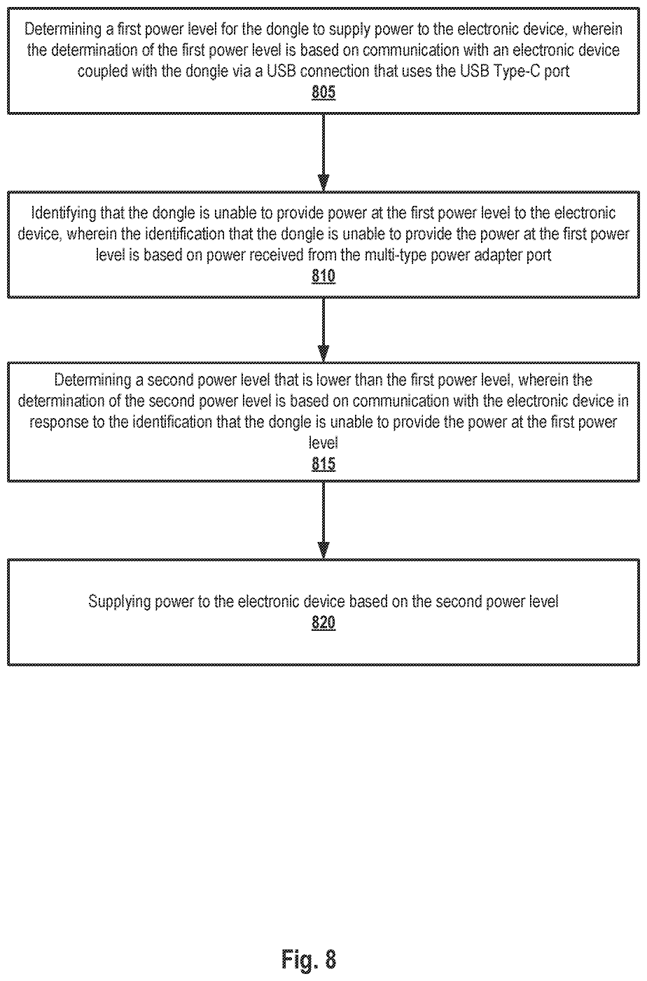

FIG. 8 illustrates an example technique that may be performed by one or more elements of the power-adapter dongle of FIG. 1, in accordance with various embodiments. While the blocks are illustrated in a particular sequence, the sequence can be modified. For example, some blocks can be performed before others, while some blocks can be performed simultaneously with other blocks. In general, the technique may be performed by a dongle such as dongle 100 and, more specifically, the PD module 120 of the dongle 100. In other embodiments the technique may be performed by additional or alternative elements, processors, logic, etc.

The technique may include determining, at 805, a first power level for the dongle to supply power to the electronic device, wherein the determination of the first power level is based on communication with an electronic device coupled with the dongle via a USB connection that uses the USB Type-C port. This communication may be similar to, for example, element 415 as previously described and may include negotiation of the first power level over the CC line. In other embodiments, element 805 may relate to a re-negotiation of a power level. In other words, the “first” power level in accordance with this technique may actually be a later-negotiated power level, and then element 815 may relate to an even later-negotiated power level.

The technique may further include identifying, at 810, that the dongle is unable to provide power at the first power level to the electronic device, wherein the identification that the dongle is unable to provide the power at the first power level is based on power received from the multi-type power adapter port. Such identification may be based on, for example, identification of a power droop as previously described. In this case, such identification may the be based on an alarm transmitted by a power monitor such as power monitor 115. The identification may be similar to, for example, element 425 or 440 as described above. However, as previously described, in other embodiments the identification at 810 may be based on some other communication or factor such as communication received from the power supply that is communicatively coupled with the multi-type power adapter port.

The technique may further include determining, at 815, a second power level that is lower than the first power level, wherein the determination of the second power level is based on communication with the electronic device in response to the identification that the dongle is unable to provide the power at the first power level. Such determination of the second power level may be similar to element 455 as described above, and may be based on reduction from the first power level by an interval, reduction from the first power level by a percentage, a change in accordance with a pre-defined data structure, etc. The technique may further include supplying, at 820, power to the electronic device based on the second power level as previously described.

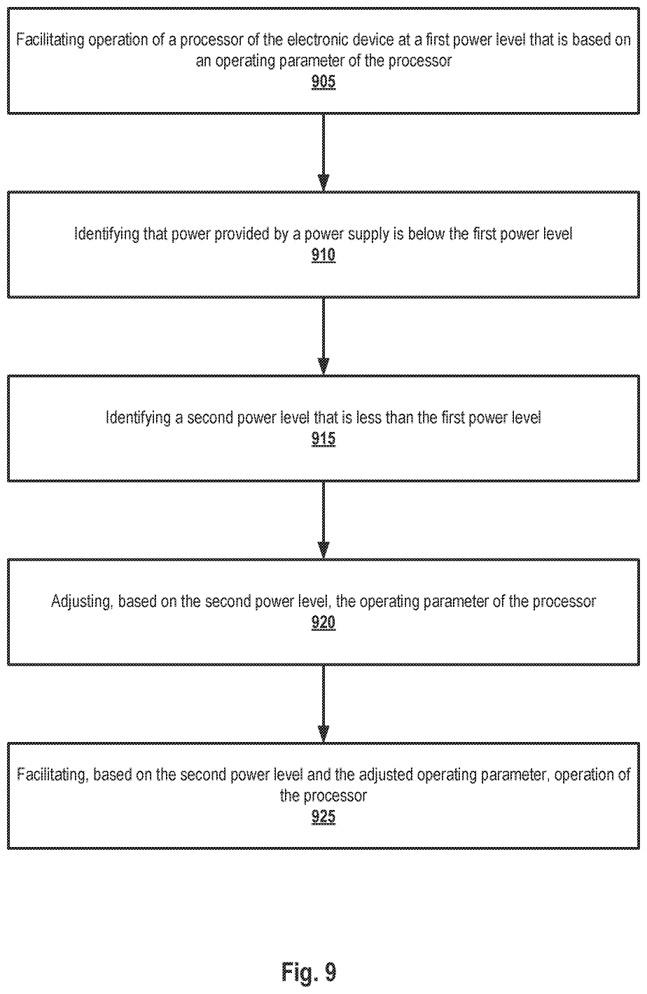

FIG. 9 illustrates an example technique that may be performed by one or more elements of the electronic device of FIG. 5, in accordance with various embodiments. While the blocks are illustrated in a particular sequence, the sequence can be modified. For example, some blocks can be performed before others, while some blocks can be performed simultaneously with other blocks. In general, the technique may be performed by an electronic device such as electronic device 500 and, more specifically, the EC 530 of the electronic device 500. In other embodiments the technique may be performed by additional or alternative elements, processors, logic, etc.

The technique may include facilitating, at 905, operation of a processor of the electronic device at a first power level that is based on an operating parameter of the processor. The operating parameter may be, for example, related to a number of active cores or elements of the processor, the frequency at which the cores of the processor operate, etc. As described, the processor may have a first power level (e.g., a power rating) that is viewed as sufficient to operate the processor. Facilitation of operation of the processor may include controlling different elements of the electronic device 500 (e.g., the voltage regulator or some other element) to provide the desired voltage to the processor 540, or providing instructions to a PMC of the processor 540 as described above. This operation may be similar to that described with respect to elements 720 or 730, as described above. Similarly to element 805, in some embodiments the first power level at 905 may be the power level based on the initial power profile (as described at 715). In other embodiments, the “first” power level for the sake of this element may be a later power level (e.g., after one or more iterations of the process of FIG. 7). Generally, the “first” power level may be considered to be a power level that is higher than the “second,” and subsequent, power level identified at 915.

The technique may further include identifying, at 910, that power provided by a power supply at a power input of the electronic device is below the first power level. This identification may be based on an alarm provided by power monitor 515 as described at elements 725 or 745. Such alarm may be based on, for example, determination of power droop. In other embodiments, the identification at 910 may be based on communication between the power supply and the electronic device, or some other factor.

The technique may further include identifying, at 915, a second power level that is less than the first power level. Such identification may be similar to, for example, element 755 as described above.

The technique may further include adjusting, at 920 based on the second power level, the operating parameter of the processor. Such adjustment may be similar to element 760, described above.

The technique may then include facilitating, at 925 based on the second power level and the adjusted operating parameter, operation of the processor as described with respect to element 765 and subsequent discussion.

It will be understood that the flowcharts of FIGS. 8 and/or 9 can be performed partially or wholly by software providing in a machine-readable storage medium (e.g., memory). The software is stored as computer-executable instructions (e.g., instructions to implement any other processes discussed herein). Program software code/instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, the program software code/instructions associated with flowchart (and/or various embodiments) are executed by the processor system.

In some embodiments, the program software code/instructions associated with the flowchart (and/or various embodiments) are stored in a computer executable storage medium and executed by the processor. Here, the computer executable storage medium is a tangible machine readable medium that can be used to store program software code/instructions and data that, when executed by a computing device, causes one or more processors to perform a method(s) as may be recited in one or more accompanying claims directed to the disclosed subject matter.

The tangible machine-readable medium may include storage of the executable software program code/instructions and data in various tangible locations, including for example ROM, volatile RAM, non-volatile memory and/or cache and/or other tangible memory as referenced in the present application. Portions of this program software code/instructions and/or data may be stored in any one of these storage and memory devices. Further, the program software code/instructions can be obtained from other storage, including, e.g., through centralized servers or peer to peer networks and the like, including the Internet. Different portions of the software program code/instructions and data can be obtained at different times and in different communication sessions or in the same communication session.

The software program code/instructions (associated with the flowchart and other embodiments) and data can be obtained in their entirety prior to the execution of a respective software program or application by the computing device. Alternatively, portions of the software program code/instructions and data can be obtained dynamically, e.g., just in time, when needed for execution. Alternatively, some combination of these ways of obtaining the software program code/instructions and data may occur, e.g., for different applications, components, programs, objects, modules, routines or other sequences of instructions or organization of sequences of instructions, by way of example. Thus, it is not required that the data and instructions be on a tangible machine readable medium in entirety at a particular instance of time.

Examples of the tangible computer-readable media include but are not limited to recordable and non-recordable type media such as volatile and non-volatile memory devices, read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs), etc.), among others. The software program code/instructions may be temporarily stored in digital tangible communication links while implementing electrical, optical, acoustical or other forms of propagating signals, such as carrier waves, infrared signals, digital signals, etc. through such tangible communication links.

In general, tangible machine readable medium includes any tangible mechanism that provides (e.g., stores and/or transmits in digital form, e.g., data packets) information in a form accessible by a machine (e.g., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an iPhone®, Galaxy®, Blackberry® Droid®, or the like, or any other device including a computing device. In one embodiment, processor-based system is in a form of or included within a PDA (personal digital assistant), a cellular phone, a notebook computer, a tablet, a game console, a set top box, an embedded system, a TV (television), a personal desktop computer, etc. Alternatively, the traditional communication applications and subsidized application(s) may be used in some embodiments of the disclosed subject matter.

FIG. 10 illustrates a smart device or a computer system or a System-on-Chip (SoC) with apparatus and/or software for implementing a power monitor or coupling with a dongle that includes a power monitor, in accordance with some embodiments. Generally, the electronic device 1000 may be similar to, and share one or more characteristics with, electronic device 500.

In some embodiments, device 1000 represents an appropriate computing device, such as a computing tablet, a mobile phone or smart-phone, a laptop, a desktop, an Internet-of-Things (IOT) device, a server, a wearable device, a set-top box, a wireless-enabled e-reader, or the like. It will be understood that certain components are shown generally, and not all components of such a device are shown in device 1000. The apparatus and/or software for controlling wake sources in a system to reduce power consumption in sleep state can be in the wireless connectivity circuitries 1031, PCU 1010, and/or other logic blocks (e.g., operating system 1052) that can manage power for the computer system.

In an example, the device 1000 comprises an SoC (System-on-Chip) 1001. An example boundary of the SoC 1001 is illustrated using dotted lines in FIG. 10, with some example components being illustrated to be included within SoC 1001—however, SoC 1001 may include any appropriate components of device 1000.

In some embodiments, device 1000 includes processor 1004. Processor 1004 can include one or more physical devices, such as microprocessors, application processors, microcontrollers, programmable logic devices, processing cores, or other processing means. The processing operations performed by processor 1004 include the execution of an operating platform or operating system on which applications and/or device functions are executed. The processing operations include operations related to I/O (input/output) with a human user or with other devices, operations related to power management, operations related to connecting computing device 1000 to another device, and/or the like. The processing operations may also include operations related to audio I/O and/or display I/O.

In some embodiments, processor 1004 includes multiple processing cores (also referred to as cores) 1008a, 1008b, 1008c. Although merely three cores 1008a, 1008b, 1008c are illustrated in FIG. 10, processor 1004 may include any other appropriate number of processing cores, e.g., tens, or even hundreds of processing cores. Processor cores 1008a, 1008b, 1008c may be implemented on a single integrated circuit (IC) chip. Moreover, the chip may include one or more shared and/or private caches, buses or interconnections, graphics and/or memory controllers, or other components.

In some embodiments, processor 1004 includes cache 1006. In an example, sections of cache 1006 may be dedicated to individual cores 1008 (e.g., a first section of cache 1006 dedicated to core 1008a, a second section of cache 1006 dedicated to core 1008b, and so on). In an example, one or more sections of cache 1006 may be shared among two or more of cores 1008. Cache 1006 may be split in different levels, e.g., level 1 (L1) cache, level 2 (L2) cache, level 3 (L3) cache, etc.

In some embodiments, processor core 1004 may include a fetch unit to fetch instructions (including instructions with conditional branches) for execution by the core 1004. The instructions may be fetched from any storage devices such as the memory 1030. Processor core 1004 may also include a decode unit to decode the fetched instruction. For example, the decode unit may decode the fetched instruction into a plurality of micro-operations. Processor core 1004 may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, execution unit may execute instructions out-of-order. Hence, processor core 1004 may be an out-of-order processor core in one embodiment. Processor core 1004 may also include a retirement unit. The retirement unit may retire executed instructions after they are committed. In an embodiment, retirement of the executed instructions may result in processor state being committed from the execution of the instructions, physical registers used by the instructions being de-allocated, etc. Processor core 1004 may also include a bus unit to enable communication between components of processor core 1004 and other components via one or more buses. Processor core 1004 may also include one or more registers to store data accessed by various components of the core 1004 (such as values related to assigned app priorities and/or sub-system states (modes) association.

In some embodiments, device 1000 comprises connectivity circuitries 1031. For example, connectivity circuitries 1031 includes hardware devices (e.g., wireless and/or wired connectors and communication hardware) and/or software components (e.g., drivers, protocol stacks), e.g., to enable device 1000 to communicate with external devices. Device 1000 may be separate from the external devices, such as other computing devices, wireless access points or base stations, etc.

In an example, connectivity circuitries 1031 may include multiple different types of connectivity. To generalize, the connectivity circuitries 1031 may include cellular connectivity circuitries, wireless connectivity circuitries, etc. Cellular connectivity circuitries of connectivity circuitries 1031 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 1031 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 1031 may include a network interface, such as a wired or wireless interface, e.g., so that a system embodiment may be incorporated into a wireless device, for example, a cell phone or personal digital assistant.

In some embodiments, device 1000 comprises control hub 1032, which represents hardware devices and/or software components related to interaction with one or more I/O devices. For example, processor 1004 may communicate with one or more of display 1022, one or more peripheral devices 1024, storage devices 1028, one or more other external devices 1029, etc., via control hub 1032. Control hub 1032 may be a chipset, a Platform Control Hub (PCH), and/or the like. Generally, the control hub 1032 may include one or more of the elements (e.g., the EC or some other element) depicted with respect to FIG. 5. The dongle may be represented in FIG. 10 as one or more of the peripheral devices 1024 and/or other external devices 1029.

For example, control hub 1032 illustrates one or more connection points for additional devices that connect to device 1000, e.g., through which a user might interact with the system. For example, devices (e.g., devices 1029) that can be attached to device 1000 include microphone devices, speaker or stereo systems, audio devices, video systems or other display devices, keyboard or keypad devices, or other I/O devices for use with specific applications such as card readers or other devices.

As mentioned above, control hub 1032 can interact with audio devices, display 1022, etc. For example, input through a microphone or other audio device can provide input or commands for one or more applications or functions of device 1000. Additionally, audio output can be provided instead of, or in addition to display output. In another example, if display 1022 includes a touch screen, display 1022 also acts as an input device, which can be at least partially managed by control hub 1032. There can also be additional buttons or switches on computing device 1000 to provide I/O functions managed by control hub 1032. In one embodiment, control hub 1032 manages devices such as accelerometers, cameras, light sensors or other environmental sensors, or other hardware that can be included in device 1000. The input can be part of direct user interaction, as well as providing environmental input to the system to influence its operations (such as filtering for noise, adjusting displays for brightness detection, applying a flash for a camera, or other features).

In some embodiments, control hub 1032 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 1022 represents hardware (e.g., display devices) and software (e.g., drivers) components that provide a visual and/or tactile display for a user to interact with device 1000. Display 1022 may include a display interface, a display screen, and/or hardware device used to provide a display to a user. In some embodiments, display 1022 includes a touch screen (or touch pad) device that provides both output and input to a user. In an example, display 1022 may communicate directly with the processor 1004. Display 1022 can be one or more of an internal display device, as in a mobile electronic device or a laptop device or an external display device attached via a display interface (e.g., DisplayPort, etc.). In one embodiment display 1022 can be a head mounted display (HMD) such as a stereoscopic display device for use in virtual reality (VR) applications or augmented reality (AR) applications.

In some embodiments, and although not illustrated in the figure, in addition to (or instead of) processor 1004, device 1000 may include Graphics Processing Unit (GPU) comprising one or more graphics processing cores, which may control one or more aspects of displaying contents on display 1022.

Control hub 1032 (or platform controller hub) may include hardware interfaces and connectors, as well as software components (e.g., drivers, protocol stacks) to make peripheral connections, e.g., to peripheral devices 1024.

It will be understood that device 1000 could both be a peripheral device to other computing devices, as well as have peripheral devices connected to it. Device 1000 may have a “docking” connector to connect to other computing devices for purposes such as managing (e.g., downloading and/or uploading, changing, synchronizing) content on device 1000. Additionally, a docking connector can allow device 1000 to connect to certain peripherals that allow computing device 1000 to control content output, for example, to audiovisual or other systems.

In addition to a proprietary docking connector or other proprietary connection hardware, device 1000 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 1031 may be coupled to control hub 1032, e.g., in addition to, or instead of, being coupled directly to the processor 1004. In some embodiments, display 1022 may be coupled to control hub 1032, e.g., in addition to, or instead of, being coupled directly to processor 1004.

In some embodiments, device 1000 comprises memory 1030 coupled to processor 1004 via memory interface 1034. Memory 1030 includes memory devices for storing information in device 1000.

In some embodiments, memory 1030 includes apparatus to maintain stable clocking as described with reference to various embodiments. Memory can include nonvolatile (state does not change if power to the memory device is interrupted) and/or volatile (state is indeterminate if power to the memory device is interrupted) memory devices. Memory device 1030 can be a dynamic random-access memory (DRAM) device, a static random-access memory (SRAM) device, flash memory device, phase-change memory device, or some other memory device having suitable performance to serve as process memory. In one embodiment, memory 1030 can operate as system memory for device 1000, to store data and instructions for use when the one or more processors 1004 executes an application or process. Memory 1030 can store application data, user data, music, photos, documents, or other data, as well as system data (whether long-term or temporary) related to the execution of the applications and functions of device 1000.

Elements of various embodiments and examples are also provided as a machine-readable medium (e.g., memory 1030) for storing the computer-executable instructions (e.g., instructions to implement any other processes discussed herein). The machine-readable medium (e.g., memory 1030) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 1000 comprises temperature measurement circuitries 1040, e.g., for measuring temperature of various components of device 1000. In an example, temperature measurement circuitries 1040 may be embedded, or coupled or attached to various components, whose temperature are to be measured and monitored. For example, temperature measurement circuitries 1040 may measure temperature of (or within) one or more of cores 1008a, 1008b, 1008c, voltage regulator 1014, memory 1030, a mother-board of SoC 1001, and/or any appropriate component of device 1000.

In some embodiments, device 1000 comprises power measurement circuitries 1042, e.g., for measuring power consumed by one or more components of the device 1000. In an example, in addition to, or instead of, measuring power, the power measurement circuitries 1042 may measure voltage and/or current. In an example, the power measurement circuitries 1042 may be embedded, or coupled or attached to various components, whose power, voltage, and/or current consumption are to be measured and monitored. For example, power measurement circuitries 1042 may measure power, current and/or voltage supplied by one or more voltage regulators 1014, power supplied to SoC 1001, power supplied to device 1000, power consumed by processor 1004 (or any other component) of device 1000, etc.

In some embodiments, device 1000 comprises one or more voltage regulator circuitries, generally referred to as voltage regulator (VR) 1014. VR 1014 generates signals at appropriate voltage levels, which may be supplied to operate any appropriate components of the device 1000. Merely as an example, VR 1014 is illustrated to be supplying signals to processor 1004 of device 1000. In some embodiments, VR 1014 receives one or more Voltage Identification (VID) signals, and generates the voltage signal at an appropriate level, based on the VID signals. Various type of VRs may be utilized for the VR 1014. For example, VR 1014 may include a “buck” VR, “boost” VR, a combination of buck and boost VRs, low dropout (LDO) regulators, switching DC-DC regulators, constant-on-time controller-based DC-DC regulator, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR, which is controlled by PCU 1010a/b and/or PMIC 1012. In some embodiments, each core has a network of distributed LDOs to provide efficient control for power management. The LDOs can be digital, analog, or a combination of digital or analog LDOs. In some embodiments, VR 1014 includes current tracking apparatus to measure current through power supply rail(s).

In some embodiments, device 1000 comprises one or more clock generator circuitries, generally referred to as clock generator 1016. Clock generator 1016 generates clock signals at appropriate frequency levels, which may be supplied to any appropriate components of device 1000. Merely as an example, clock generator 1016 is illustrated to be supplying clock signals to processor 1004 of device 1000. In some embodiments, clock generator 1016 receives one or more Frequency Identification (FID) signals, and generates the clock signals at an appropriate frequency, based on the FID signals.

In some embodiments, device 1000 comprises battery 1018 supplying power to various components of device 1000. Merely as an example, battery 1018 is illustrated to be supplying power to processor 1004. Although not illustrated in the figures, device 1000 may comprise a charging circuitry, e.g., to recharge the battery, based on Alternating Current (AC) power supply received from an AC adapter.

In some embodiments, device 1000 comprises Power Control Unit (PCU) 1010 (also referred to as Power Management Unit (PMU), Power Controller, etc.). In an example, some sections of PCU 1010 may be implemented by one or more processing cores 1008, and these sections of PCU 1010 are symbolically illustrated using a dotted box and labelled PCU 1010a. In an example, some other sections of PCU 1010 may be implemented outside the processing cores 1008, and these sections of PCU 1010 are symbolically illustrated using a dotted box and labelled as PCU 1010b. PCU 1010 may implement various power management operations for device 1000. PCU 1010 may include hardware interfaces, hardware circuitries, connectors, registers, etc., as well as software components (e.g., drivers, protocol stacks), to implement various power management operations for device 1000.

In some embodiments, device 1000 comprises Power Management Integrated Circuit (PMIC) 1012, e.g., to implement various power management operations for device 1000. In some embodiments, PMIC 1012 is a Reconfigurable Power Management ICs (RPMICs) and/or an IMVP (Intel® Mobile Voltage Positioning). In an example, the PMIC is within an IC chip separate from processor 1004. The may implement various power management operations for device 1000. PMIC 1012 may include hardware interfaces, hardware circuitries, connectors, registers, etc., as well as software components (e.g., drivers, protocol stacks), to implement various power management operations for device 1000.

In an example, device 1000 comprises one or both PCU 1010 or PMIC 1012. In an example, any one of PCU 1010 or PMIC 1012 may be absent in device 1000, and hence, these components are illustrated using dotted lines.

Various power management operations of device 1000 may be performed by PCU 1010, by PMIC 1012, or by a combination of PCU 1010 and PMIC 1012. For example, PCU 1010 and/or PMIC 1012 may select a power state (e.g., P-state) for various components of device 1000. For example, PCU 1010 and/or PMIC 1012 may select a power state (e.g., in accordance with the ACPI (Advanced Configuration and Power Interface) specification) for various components of device 1000. Merely as an example, PCU 1010 and/or PMIC 1012 may cause various components of the device 1000 to transition to a sleep state, to an active state, to an appropriate C state (e.g., CO state, or another appropriate C state, in accordance with the ACPI specification), etc. In an example, PCU 1010 and/or PMIC 1012 may control a voltage output by VR 1014 and/or a frequency of a clock signal output by the clock generator, e.g., by outputting the VID signal and/or the FID signal, respectively. In an example, PCU 1010 and/or PMIC 1012 may control battery power usage, charging of battery 1018, and features related to power saving operation.

The clock generator 1016 can comprise a phase locked loop (PLL), frequency locked loop (FLL), or any suitable clock source. In some embodiments, each core of processor 1004 has its own clock source. As such, each core can operate at a frequency independent of the frequency of operation of the other core. In some embodiments, PCU 1010 and/or PMIC 1012 performs adaptive or dynamic frequency scaling or adjustment. For example, clock frequency of a processor core can be increased if the core is not operating at its maximum power consumption threshold or limit. In some embodiments, PCU 1010 and/or PMIC 1012 determines the operating condition of each core of a processor, and opportunistically adjusts frequency and/or power supply voltage of that core without the core clocking source (e.g., PLL of that core) losing lock when the PCU 1010 and/or PMIC 1012 determines that the core is operating below a target performance level. For example, if a core is drawing current from a power supply rail less than a total current allocated for that core or processor 1004, then PCU 1010 and/or PMIC 1012 can temporality increase the power draw for that core or processor 1004 (e.g., by increasing clock frequency and/or power supply voltage level) so that the core or processor 1004 can perform at higher performance level. As such, voltage and/or frequency can be increased temporality for processor 1004 without violating product reliability.

In an example, PCU 1010 and/or PMIC 1012 may perform power management operations, e.g., based at least in part on receiving measurements from power measurement circuitries 1042, temperature measurement circuitries 1040, charge level of battery 1018, and/or any other appropriate information that may be used for power management. To that end, PMIC 1012 is communicatively coupled to one or more sensors to sense/detect various values/variations in one or more factors having an effect on power/thermal behavior of the system/platform. Examples of the one or more factors include electrical current, power droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 1010 and/or PMIC 1012 in at least one embodiment to allow PCU 1010 and/or PMIC 1012 to manage processor core energy at least in part based on value(s) detected by one or more of the sensors.

Also illustrated is an example software stack of device 1000 (although not all elements of the software stack are illustrated). Merely as an example, processors 1004 may execute application programs 1050, Operating System 1052, one or more Power Management (PM) specific application programs (e.g., generically referred to as PM applications 1058), and/or the like. PM applications 1058 may also be executed by the PCU 1010 and/or PMIC 1012. OS 1052 may also include one or more PM applications 1056a, 1056b, 1056c. The OS 1052 may also include various drivers 1054a, 1054b, 1054c, etc., some of which may be specific for power management purposes. In some embodiments, device 1000 may further comprise a Basic Input/output System (BIOS) 1020. BIOS 1020 may communicate with OS 1052 (e.g., via one or more drivers 1054), communicate with processors 1004, etc.

For example, one or more of PM applications 1058, 1056, drivers 1054, BIOS 1020, etc. may be used to implement power management specific tasks, e.g., to control voltage and/or frequency of various components of device 1000, to control wake-up state, sleep state, and/or any other appropriate power state of various components of device 1000, control battery power usage, charging of the battery 1018, features related to power saving operation, etc.

In some embodiments, battery 1018 is a Li-metal battery with a pressure chamber to allow uniform pressure on a battery. The pressure chamber is supported by metal plates (such as pressure equalization plate) used to give uniform pressure to the battery. The pressure chamber may include pressured gas, elastic material, spring plate, etc. The outer skin of the pressure chamber is free to bow, restrained at its edges by (metal) skin, but still exerts a uniform pressure on the plate that is compressing the battery cell. The pressure chamber gives uniform pressure to battery, which is used to enable high-energy density battery with, for example, 20% more battery life.

In some embodiments, pCode executing on PCU 1010a/b has a capability to enable extra compute and telemetries resources for the runtime support of the pCode. Here pCode refers to a firmware executed by PCU 1010a/b to manage performance of the SoC 1001. For example, pCode may set frequencies and appropriate voltages for the processor. Part of the pCode are accessible via OS 1052. In various embodiments, mechanisms and methods are provided that dynamically change an Energy Performance Preference (EPP) value based on workloads, user behavior, and/or system conditions. There may be a well-defined interface between OS 1052 and the pCode. The interface may allow or facilitate the software configuration of several parameters and/or may provide hints to the pCode. As an example, an EPP parameter may inform a pCode algorithm as to whether performance or battery life is more important.

This support may be done as well by the OS 1052 by including machine-learning support as part of OS 1052 and either tuning the EPP value that the OS hints to the hardware (e.g., various components of SoC 1001) by machine-learning prediction, or by delivering the machine-learning prediction to the pCode in a manner similar to that done by a Dynamic Tuning Technology (DTT) driver. In this model, OS 1052 may have visibility to the same set of telemetries as are available to a DTT. As a result of a DTT machine-learning hint setting, pCode may tune its internal algorithms to achieve optimal power and performance results following the machine-learning prediction of activation type. The pCode as example may increase the responsibility for the processor utilization change to enable fast response for user activity, or may increase the bias for energy saving either by reducing the responsibility for the processor utilization or by saving more power and increasing the performance lost by tuning the energy saving optimization. This approach may facilitate saving more battery life in case the types of activities enabled lose some performance level over what the system can enable. The pCode may include an algorithm for dynamic EPP that may take the two inputs, one from OS 1052 and the other from software such as DTT, and may selectively choose to provide higher performance and/or responsiveness. As part of this method, the pCode may enable in the DTT an option to tune its reaction for the DTT for different types of activity.

Some non-limiting Examples of various embodiments are presented below.

Example 1 includes a method to be performed by a dongle that includes a multi-type power adapter port and a universal serial bus (USB) Type-C port, wherein the method comprises: determining, based on communication with an electronic device coupled with the dongle via a USB connection that uses the USB Type-C port, a first power level for the dongle to supply power to the electronic device; identifying, while supplying power to the electronic device in accordance with the first power level, a power droop at the dongle; determining, based on communication with the electronic device in response to the power droop, a second power level that is lower than the first power level; and supplying power to the electronic device based on the second power level.

Example 2 includes the method of example 1, and/or some other example herein, wherein the dongle is to communicate with the electronic device to identify the first power level or the second power level via a communication channel (CC) of the USB connection.

Example 3 includes the method of any of examples 1-2, and/or some other example herein, wherein the determining the first power level is responsive to boot process of the electronic device.

Example 4 includes the method of any of examples 1-3, and/or some other example herein, wherein the determining the first power level is responsive to a workload of the electronic device.

Example 5 includes the method of any of examples 1-4, and/or some other example herein, wherein the determining the second power level is based on an alarm generated by a power monitor of the dongle based on the power droop.

Example 6 includes the method of any of examples 1-5, and/or some other example herein, wherein the power droop is based on a power provided by a power supply coupled with the dongle via the power adapter port being lower than the first power level.

Example 7 includes a dongle comprising: a multi-type power adapter port to receive power from a power source; a universal serial bus (USB) Type-C port to provide power at a first power level to an electronic device coupled with the dongle via a USB connection; a power monitor to identify whether the power received from the power source is less than the first power level; and a power delivery (PD) module communicatively coupled with the power monitor, wherein the PD module is to: determine, based on communication with the electronic device in response to identification by the power monitor that the power received from the power source is less than the first power level, a second power level that is less than the first power level; and facilitate provision of power to the system at the second power level.

Example 8 includes the dongle of example 7, and/or some other example herein, wherein the power monitor is to identify that the power received from the power source is less than the first power level based on a power droop that occurs while the dongle is supplying power to the electronic device at the first power level.

Example 9 includes the dongle of any of examples 7-8, and/or some other example herein, wherein the PD module is to communicate with the electronic device to identify the second power level via a communication channel (CC) of the USB connection.

Example 10 includes the dongle of any of examples 7-9, and/or some other example herein, wherein the PD module is further to determine the first power level is responsive to a boot process of the electronic device.

Example 11 includes the dongle of any of examples 7-10, and/or some other example herein, wherein the PD module is further to determine the first power level responsive to a workload of the electronic device.

Example 12 includes the dongle of any of examples 7-11, and/or some other example herein, wherein the power monitor is to generate an alarm based on the identification that the power received from the power source is less than the first power level; and wherein the PD controller is to determine the second power level based on the alarm.

Example 13 includes a method to be performed by an embedded controller (EC) of an electronic device that is coupled to a power supply, wherein the method comprises: facilitating operation of a processor of the electronic device at a first power level that is based on an operating parameter of the processor; identifying that power provided by the power supply is below the first power level; identifying a second power level that is less than the first power level; adjusting, based on the second power level, the operating parameter of the processor; and facilitating, based on the second power level and the adjusted operating parameter, operation of the processor.

Example 14 includes the method of example 13, and/or some other example herein, wherein the operating parameter relates to a boot process of the electronic device.

Example 15 includes the method of any of examples 13-14, and/or some other example herein, wherein the operating parameter relates to a workload of the processor.

Example 16 includes the method of any of examples 13-15, wherein adjusting the operating parameter includes powering down one or more cores of the processor.

Example 17 includes the method of any of examples 13-16, wherein identifying that power provided by the power supply is below the first power level is based on a comparison of the power provided by the power supply to a power threshold level.

Example 18 includes the method of example 17, and/or some other example herein, wherein the power threshold level is a percentage of the first power level.

Example 19 includes the method of example 18, and/or some other example herein, wherein the power threshold level is 80% of the first power level.

Example 20 includes the method of any of examples 13-19, and/or some other example herein, wherein identifying that the power provided by the power supply is below the first power level is based on identifying a power droop of the power provided by the power supply.

Example 21 includes the method of example 20, and/or some other example herein, further comprising identifying a maximum value of the power provided by the power supply during the power droop.

Example 22 includes the method of example 21, and/or some other example herein, wherein the second power level is based on the maximum value.

Example 23 includes the method of example 21, and/or some other example herein, wherein the second power level is equal to the maximum value.

Example 24 includes an electronic device that includes: a power input port to receive power from a power supply; a power monitor to monitor the power received from the power supply; a processor; and an embedded controller (EC), wherein the EC is to: facilitate operation of the processor unit at a first power level that is related to an operating parameter of the processing unit; identify, based on an alarm received from the power monitor that is related to occurrence of a power droop, that power provided by the power supply is below the first power level; identify, based on an indication received from the power monitor of a maximum level of the power provided by the power supply during the power droop, a second power level that is less than the first power level; facilitate adjustment of the operating parameter based on the second power level; and facilitate operation of the processor at the second power level.

Example 25 includes the electronic device of example 24, and/or some other example herein, wherein the operating parameter relates to a boot process of the electronic device.

Example 26 includes the electronic device of any of examples 24-25, and/or some other example herein, wherein the operating parameter relates to a workload of the processor.

Example 27 includes the electronic device of any of examples 24-26, and/or some other example herein, wherein facilitating adjustment of the operating parameter includes powering down one or more cores of the processor.

Example 28 includes the electronic device of any of examples 24-27, and/or some other example herein, wherein the alarm is based on a comparison, by the power monitor, of the power provided by the power supply to a power threshold level.

Example 29 includes the electronic device of example 28, and/or some other example herein, wherein the power threshold level is a percentage of the first power level.

Example 30 includes the electronic device of example 29, and/or some other example herein, wherein the power threshold level is 80% of the first power level.

Example 31 includes the electronic device of any of examples 24-29, and/or some other example herein, wherein the second power level is equal to the maximum level of the power provided by the power supply during the power droop.

Example 32 includes a dongle comprising: a multi-type power adapter port; a universal serial bus (USB) Type-C port; and circuitry coupled with the multi-type power adapter port and the USB Type-C port, wherein the circuitry is to: determine a first power level for the dongle to supply power to the electronic device, wherein the determination of the first power level is based on communication with an electronic device coupled with the dongle via a USB connection that uses the USB Type-C port; identify that the dongle is unable to provide power at the first power level to the electronic device, wherein the identification that the dongle is unable to provide the power at the first power level is based on power received from the multi-type power adapter port; determine a second power level that is lower than the first power level, wherein the determination of the second power level is based on communication with the electronic device in response to the identification that the dongle is unable to provide the power at the first power level; and supply power to the electronic device based on the second power level.

Example 33 includes the dongle of example 32, and/or some other example herein, wherein the dongle is to communicate with the electronic device to identify the first power level or the second power level via a communication channel (CC) of the USB connection.

Example 34 includes the dongle of any of examples 32-33, and/or some other example herein, wherein determination of the first power level is responsive to boot process of the electronic device.

Example 35 includes the dongle of any of examples 32-34, and/or some other example herein, wherein determination of the first power level is responsive to a workload of the electronic device.

Example 36 includes the dongle of any of examples 32-35, and/or some other example herein, wherein determination of the second power level is based on an alarm generated by a power monitor of the dongle.

Example 37 includes the dongle of example 36, and/or some other example herein, wherein the alarm is based on identification of a power droop while the dongle is attempting to supply power to the electronic device at the first power level.

Example 38 includes the dongle of example 36, and/or some other example herein, wherein the power droop is based on a power provided by a power supply coupled with the dongle via the power adapter port being lower than the first power level.

Example 39 includes the dongle of any of examples 32-38, and/or some other example herein, wherein the multi-type port is configurable to couple with a tubular port and a flat port.

Example 40 includes a dongle comprising: a multi-type power adapter port to receive power from a power source; a universal serial bus (USB) Type-C port to provide power at a first power level to an electronic device coupled with the dongle via a USB connection; a power monitor to identify whether the power received from the power source is less than the first power level; and a power delivery (PD) module communicatively coupled with the power monitor, wherein the PD module is to: determine a second power level that is less than the first power level, wherein determination of the second power level is based on communication with the electronic device in response to identification by the power monitor that the power received from the power source is less than the first power level; and facilitate provision of power to the system at the second power level.

Example 41 includes the dongle of example 40, and/or some other example herein, wherein the power monitor is to identify that the power received from the power source is less than the first power level based on a power droop that occurs while the dongle is supplying power to the electronic device at the first power level.

Example 42 includes the dongle of any of examples 40-41, and/or some other example herein, wherein the PD module is to communicate with the electronic device to identify the second power level via a communication channel (CC) of the USB connection.

Example 43 includes the dongle of any of examples 40-42, and/or some other example herein, wherein the PD module is further to determine the first power level is responsive to a boot process of the electronic device.

Example 44 includes the dongle of any of examples 40-43, and/or some other example herein, wherein the PD module is further to determine the first power level responsive to a workload of the electronic device.

Example 45 includes the dongle of any of examples 40-44, and/or some other example herein, wherein the power monitor is to generate an alarm based on the identification that the power received from the power source is less than the first power level; and wherein the PD controller is to determine the second power level based on the alarm.

Example 46 includes the dongle of any of examples 40-45, and/or some other example herein, wherein the multi-type port is configurable to couple with a tubular port and a flat port.

Example 47 includes an embedded controller (EC) to be used in an electronic device, wherein the EC comprises: one or more processors; and one or more non-transitory computer-readable media comprising instructions that, upon execution of the instructions by the one or more processors, are to cause the EC to: facilitate operation of a processor of the electronic device at a first power level that is based on an operating parameter of the processor; identify that power provided by a power supply coupled to the electronic device is below the first power level; identify a second power level that is less than the first power level; adjust, based on the second power level, the operating parameter of the processor; and facilitate, based on the second power level and the adjusted operating parameter, operation of the processor.

Example 48 includes the EC of example 47, and/or some other example herein, wherein the operating parameter relates to a boot process of the electronic device.

Example 49 includes the EC of any of examples 47-48, and/or some other example herein, wherein the operating parameter relates to a workload of the processor.

Example 50 includes the EC of any of examples 47-49, and/or some other example herein, wherein adjusting the operating parameter includes powering down one or more cores of the processor.

Example 51 includes the EC of any of examples 47-50, and/or some other example herein, wherein identifying that power provided by the power supply is below the first power level is based on a comparison of the power provided by the power supply to a power threshold level.

Example 52 includes the EC of any of examples 47-51, and/or some other example herein, wherein identifying that the power provided by the power supply is below the first power level is based on identifying a power droop of the power provided by the power supply.

Example 53 includes an electronic device that includes: a power input port to receive power from a power supply; a power monitor to monitor the power received from the power supply; a processor; and an embedded controller (EC), wherein the EC is to: identify, based on an alarm received from the power monitor, that power provided by the power supply is below a first power level that is related to an operating parameter of the processing unit; identify, based on an indication received from the power monitor, a second power level that is less than the first power level; facilitate adjustment of the operating parameter based on the second power level; and facilitate operation of the processor at the second power level.

Example 54 includes the electronic device of example 53, and/or some other example herein, wherein the operating parameter relates to a boot process of the electronic device.

Example 55 includes the electronic device of any of examples 53-54, and/or some other example herein, wherein the operating parameter relates to a workload of the processor.

Example 56 includes the electronic device of any of examples 53-55, and/or some other example herein, wherein facilitating adjustment of the operating parameter includes powering down one or more cores of the processor.

Example 57 includes the electronic device of any of examples 53-56, and/or some other example herein, the alarm is based on a comparison, by the power monitor, of the power provided by the power supply to a power threshold level.

Example 58 includes the electronic device of example 57, and/or some other example herein, wherein the power threshold level is 80% of the first power level.

Example 59 includes the electronic device of any of examples 53-58, and/or some other example herein, wherein the alarm is based on occurrence of a power droop.

Example 60 includes the electronic device of example 59, and/or some other example herein, wherein the second power level is equal to the maximum level of the power provided by the power supply during the power droop.

It will be understood that, in the preceding detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the preceding detailed description is not to be taken in a limiting sense, and the scope of embodiments is defined by the appended claims and their equivalents.

Various operations may be described as multiple discrete actions or operations in turn, in a manner that may be helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the preceding disclosure, the phrases “A and/or B” and “A or B” mean (A), (B), or (A and B). For the purposes of the preceding disclosure, the phrase “A, B, and/or C” means (A), (B), (C), (A and B), (A and C), (B and C), or (A, B, and C).

The preceding description may use the phrases “in an embodiment,” or “in embodiments,” which may each refer to one or more of the same or different embodiments. Furthermore, the terms “comprising,” “including,” “having,” and the like, as used with respect to embodiments of the preceding disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics of the preceding description may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1. A dongle comprising:
a multi-type power adapter port;
a universal serial bus (USB) Type-C port; and
circuitry coupled with the multi-type power adapter port and the USB Type-C port, wherein the circuitry is to:
determine a first power level for the dongle to supply power to the electronic device, wherein the determination of the first power level is based on communication with an electronic device coupled with the dongle via a USB connection that uses the USB Type-C port;
identify that the dongle is unable to provide power at the first power level to the electronic device, wherein the identification that the dongle is unable to provide the power at the first power level is based on power received from the multi-type power adapter port;
determine a second power level that is lower than the first power level, wherein the determination of the second power level is based on communication with the electronic device in response to the identification that the dongle is unable to provide the power at the first power level; and
supply power to the electronic device based on the second power level.

2. The dongle of claim 1, wherein the dongle is to communicate with the electronic device to identify the first power level or the second power level via a communication channel (CC) of the USB connection.

3. The dongle of claim 1, wherein determination of the first power level is responsive to boot process of the electronic device.

4. The dongle of claim 1, wherein determination of the first power level is responsive to a workload of the electronic device.

5. The dongle of claim 1, wherein determination of the second power level is based on an alarm generated by a power monitor of the dongle.

6. The dongle of claim 5, wherein the alarm is based on identification of a power droop while the dongle is attempting to supply power to the electronic device at the first power level.

7. The dongle of claim 5, wherein the power droop is based on a power provided by a power supply coupled with the dongle via the power adapter port being lower than the first power level.

8. The dongle of claim 1, wherein the multi-type port is configurable to couple with a tubular port and a flat port.

9. A dongle comprising:
a multi-type power adapter port to receive power from a power source;
a universal serial bus (USB) Type-C port to provide power at a first power level to an electronic device coupled with the dongle via a USB connection;
a power monitor to identify whether the power received from the power source is less than the first power level; and
a power delivery (PD) module communicatively coupled with the power monitor, wherein the PD module is to:
determine a second power level that is less than the first power level, wherein determination of the second power level is based on communication with the electronic device in response to identification by the power monitor that the power received from the power source is less than the first power level; and
facilitate provision of power to the system at the second power level.

10. The dongle of claim 9, wherein the power monitor is to identify that the power received from the power source is less than the first power level based on a power droop that occurs while the dongle is supplying power to the electronic device at the first power level.

11. The dongle of claim 9, wherein the PD module is to communicate with the electronic device to identify the second power level via a communication channel (CC) of the USB connection.

12. The dongle of claim 9, wherein the PD module is further to determine the first power level is responsive to a boot process of the electronic device.

13. The dongle of claim 9, wherein the PD module is further to determine the first power level responsive to a workload of the electronic device.

14. The dongle of claim 9, wherein the power monitor is to generate an alarm based on the identification that the power received from the power source is less than the first power level; and
wherein the PD controller is to determine the second power level based on the alarm.

15. The dongle of claim 9, wherein the multi-type port is configurable to couple with a tubular port and a flat port.

16. An embedded controller (EC) to be used in an electronic device, wherein the EC comprises:
one or more processors; and
one or more non-transitory computer-readable media comprising instructions that, upon execution of the instructions by the one or more processors, are to cause the EC to:
facilitate operation of a processor of the electronic device at a first power level that is based on an operating parameter of the processor;
identify that power provided by a power supply coupled to the electronic device is below the first power level;
identify a second power level that is less than the first power level;
adjust, based on the second power level, the operating parameter of the processor; and
facilitate, based on the second power level and the adjusted operating parameter, operation of the processor.

17. The EC of claim 16, wherein the operating parameter relates to a boot process of the electronic device.

18. The EC of claim 16, wherein the operating parameter relates to a workload of the processor.

19. The EC of claim 16, wherein adjusting the operating parameter includes powering down one or more cores of the processor.

20. The EC of claim 16, wherein identifying that power provided by the power supply is below the first power level is based on a comparison of the power provided by the power supply to a power threshold level.

21. The EC of claim 16, wherein identifying that the power provided by the power supply is below the first power level is based on identifying a power droop of the power provided by the power supply.

22. An electronic device that includes:
a power input port to receive power from a power supply;
a power monitor to monitor the power received from the power supply;
a processor; and
an embedded controller (EC), wherein the EC is to:
identify, based on an alarm received from the power monitor, that power provided by the power supply is below a first power level that is related to an operating parameter of the processing unit;
identify, based on an indication received from the power monitor, a second power level that is less than the first power level;
facilitate adjustment of the operating parameter based on the second power level; and
facilitate operation of the processor at the second power level.

23. The electronic device of claim 22, wherein the operating parameter relates to a boot process of the electronic device.

24. The electronic device of claim 22, wherein the operating parameter relates to a workload of the processor.

25. The electronic device of claim 22, wherein facilitating adjustment of the operating parameter includes powering down one or more cores of the processor.

26. The electronic device of claim 22, the alarm is based on a comparison, by the power monitor, of the power provided by the power supply to a power threshold level.

27. The electronic device of claim 26, wherein the power threshold level is 80% of the first power level.

28. The electronic device of claim 22, wherein the alarm is based on occurrence of a power droop.

29. The electronic device of claim 28, wherein the second power level is equal to the maximum level of the power provided by the power supply during the power droop.
